(19) United States
(12) Patent Application Publication
(10) Pub. No.: US 2023/0155138 A1
(43) Pub. Date: May 18, 2023

(54) CROSSLINKED ELECTRODES FOR FUEL CELLS, ELECTROLYZERS AND REVERSIBLE DEVICES

(71) Applicant: HYDROLITE LTD, Caesarea (IL)

(72) Inventors: Miles PAGE, Hod Hasharon (IL); Aviv ASHDOT, Atlit (IL); Alina AMEL, Binyamina (IL); Ervin TAL-GUTELMACHER, Hod Hasharon (IL)

(73) Assignee: HYDROLITE LTD, Caesarea (IL)

(21) Appl. No.: 18/100,013

(22) Filed: Jan. 23, 2023

Related U.S. Application Data
(63) Continuation-in-part of application No. 16/765,539, filed on May 20, 2020.
Application No. 16/765,539 is a continuation-in-part of application No. PCT/IL18/51257, filed on Nov. 20, 2018.
Application No. PCT/IL18/51257 is a continuation-in-part of application No. 17/830,424, filed on Jun. 2, 2022.
Application No. 17/830,424 is a continuation-in-part of application No. PCT/IL22/50590, filed on Jun. 2, 2022.
(60) Provisional application No. 63/211,186, filed on Jun. 16, 2021.
(60) Provisional application No. 63/221,035, filed on Jul. 13, 2021.
(60) Provisional application No. 63/211,186, filed on Jun. 16, 2021.
(60) Provisional application No. 63/221,035, filed on Jul. 13, 2021.

(30) Foreign Application Priority Data
Nov. 6, 2022 (IL) 297987

(51) Int. Cl. H01M 4/88; H01M 8/1004

(52) U.S. Cl. CPC H01M 4/8828; H01M 4/8807; H01M 4/8857; H01M 8/1004

(57) ABSTRACT

Methods of making alkaline exchange catalytic electrodes for electrochemical devices are provided, as well as fuel cells, electrolyzers and dual reversible devices with provided electrodes and/or membrane-electrode assemblies. Methods comprise preparing a catalyst dispersion by mixing catalyst nanoparticles and polymer precursor dispersion in a solvent. The polymer precursor(s) comprise multiple types of monomer units with multiple types of functional groups that include non-cationic functional group(s) and anion-conductive functional group(s). Consecutively, the catalyst dispersion is deposited on a functional substrate and the solvent is evaporated to form a catalyst layer, and then the non-cationic functional group(s) and/or the anion-conductive group(s) are crosslinked to stabilize the catalyst layer. Membrane-electrode assemblies may be formed by the provided methods, and used in various types of electrochemical devices.

### CROSS REFERENCE TO RELATED APPLICATIONS

This application is a Continuation-In-Part of U.S. patent application Ser. No. 16/765,539 filed on May 20, 2020, which is a National Phase Application of PCT International Application No. PCT/IL2018/051257, International Filing Date Nov. 20, 2018, entitled: “MEMBRANES FOR FUELS CELLS AND METHOD OF MAKING SAME”, published on May 23, 2019, under PCT International Application Publication No. WO 2019/097527, which claims the priority of Israel Patent Application No. 255766, filed on Nov. 20, 2017, which is hereby incorporated by reference in its entirety.

This application is also a Continuation-In-Part of U.S. patent application Ser. No. 17/830,424 and of WIPO Application No. PCT/IL2022/050590, both filed on Jun. 2, 2022 and both claiming priority from U.S. Provisional Application No. 63/211,186, filed on Jun. 16, 2021, and from U.S. Provisional Application No. 63/221,035, filed on Jul. 13, 2021—which are incorporated herein by reference in their entirety.

This application also claims priority from Israeli Patent Application No. 297,987, filed on Nov. 6, 2022, which is incorporated herein by reference in its entirety.

### BACKGROUND OF THE INVENTION

### 1. Technical Field

The present invention relates to the field of electrochemical devices, and more particularly, to preparation methods of membranes for fuel cells, electrolyzers and dual devices.

### 2. Discussion of Related Art

Electrolyzers and fuel cells are electrochemical devices that produce hydrogen and consume hydrogen to produce energy, respectively, which gain uses as alternative energy sources (fuel cells) and fuel sources (electrolyzers). Combined configurations provide independent sustainable energy sources that can regenerate their hydrogen supply.

U.S. Patent Application Publication No. 20110300466, which is incorporated herein by reference in its entirety, teaches an alkaline membrane fuel cell including at least one of i) a catalyst coated OH— ion conducting membrane having a catalyst layer and an OH— ion conducting membrane, and ii) a catalyst coated carbonate ion conducting membrane having a catalyst layer and a carbonate ion conducting membrane, respectively, wherein the at least one catalyst layer is chemically bonded to a surface of the at least one membrane, wherein the chemical bonding is established by crosslinking of polymer constituents across an interface between the at least one catalyst layer and the at least one membrane.

U.S. Patent Application Publication No. 20140272663, which is incorporated herein by reference in its entirety, teaches the formation of a catalyst coated membrane (CCM) in an alkaline membrane fuel cell (AMFC), with the anode catalyst layer being selectively cross-linked while the cathode catalyst layer is not cross-linked. This has been found to provide structural stabilization of the CCM without loss of initial power value for a CCM without cross-linking.

WIPO Publication No. 2010013861, which is incorporated herein by reference in its entirety, teaches anion-exchange composite membranes containing a styrene-based and vinylbenzene-based copolymer on a porous film, that are manufactured by performing polymerization through impregnation of the porous film with a polymerization solution containing a styrene-based monomer, a vinylbenzene-based monomer, a crosslinking agent and an initiator, and introducing ammonium ions.

U.S. Patent Application Publication No. 20130146471, which is incorporated herein by reference in its entirety, teaches a membrane-electrode assembly for use in a reversible fuel cell comprises an ion conductive membrane having first and second surfaces; a first electrocatalyst layer in contact with the first surface of the membrane, such first electrocatalyst layer comprising at least one discrete electrolysis-active area and at least one discrete energy generation-active area. A second electrocatalyst layer is placed in contact with the second surface of the membrane, such second electrocatalyst layer comprising at least one discrete electrolysis-active area and at least one discrete energy generation-active area. Each of the discrete electrolysis-active area(s) on the first electrocatalyst layer correspond and are aligned with each of the discrete electrolysis-active area(s) on the second electrocatalyst layer, and each of the discrete energy generation-active area(s) on the first electrocatalyst layer correspond and are aligned with each of the discrete energy generation-active area(s) on the second electrocatalyst layer.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a method of making alkaline exchange catalytic electrodes for an electrochemical device, the method comprising: preparing a catalyst dispersion by mixing at least one type of catalyst nanoparticles and at least one polymer precursor dispersion in a solvent, the at least one polymer precursor comprising at least two types of monomer units having respective at least two types of functional groups that comprise at least one non-cationic functional group, and at least one anion-conductive functional group, depositing the catalyst dispersion on a functional substrate and evaporating the solvent to form a catalyst layer, and crosslinking at least one of the non-cationic functional groups and/or the anion-conductive groups to stabilize the catalyst layer.

One aspect of the present invention provides a membrane-electrode assembly comprising two catalytic electrodes separated by an anion-conducting separation layer, wherein at least one of the electrodes is prepared by the disclosed methods.

One aspect of the present invention provides a reversible electrochemical device comprising the disclosed membrane-electrode assembly, wherein the two catalytic electrodes comprise a hydrogen evolution/oxidation reaction (HER/HOR) electrode comprising a carbon-based gas diffusion electrode (GDE), and an oxygen evolution/reduction reaction (OER/ORR) electrode comprising a metal-based GDE.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. In the accompanying drawings:

FIG. 1 is a high-level flowchart illustrating methods of making alkaline exchange catalytic electrodes for an electrochemical device, according to some embodiments of the invention.

FIG. 2 is a high-level schematic block diagram of elements in the preparation of electrodes and devices, according to some embodiments of the invention.

FIGS. 3A and 3B illustrate schematically the prior art amination and crosslinking reactions of styrene-based precursor polymer to form positively charged quaternary ammonium anion conducting groups, and to form linkage between two polymer chains using tetra-methyl-1,6-hexane di-amine (TMHDA) cross linker agent, respectively.

FIGS. 4A-4C provide schematic examples for methods including polymerization, crosslinking and functionalization reactions, according to some embodiments of the invention.

FIG. 5A provides a non-limiting example for polymerization, crosslinking and functionalization reactions according to some embodiments of the invention.

FIG. 5B provides non-limiting examples for ion conducting functional groups according to some embodiments of the invention.

FIGS. 6A-6C, 7A-7C, 8A and 8B and are high-level schematic illustration of membranes and CCMs, according to some embodiments of the invention.

FIG. 9 is a high-level schematic illustration of a self-refueling power-generating system with reversible device(s), according to some embodiments of the invention.

FIG. 10 is a high-level flowchart illustrating a method of configuring a power-generating system to be self-refueling and self-sustaining, according to some embodiments of the invention.

FIG. 11 is a high-level schematic illustration of the operation of reversible devices in fuel cell mode and in electrolyzer mode, according to some embodiments of the invention.

FIG. 12A is a high-level schematic block diagram of an electrolyzer, according to some embodiments of the invention

FIG. 12B is a high-level schematic block diagram of a fuel cell, according to some embodiments of the invention.

FIG. 12C is a high-level schematic block diagram of a dual cell, according to some embodiments of the invention.

FIG. 13 is a high-level flowchart illustrating a method, according to some embodiments of the invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

As the use of solid membrane fuel cells expands, there is a constant need to improve the stability and efficiency of the fuel cells. Both alkaline exchange membrane (AEM) fuel cells and proton exchange membrane (PEM) fuel cells have a similar basic structure that includes a polymeric conducting membrane, and an anode and a cathode catalyst layer, one layer on each side of the membrane. The AEM and PEM fuel cells differ at least in the electrochemical reactions and the ion conducting groups in the polymeric conducting membrane, in the anode catalyst layer, and in the cathode catalyst layer.

Increasing stability and mechanical durability of the polymeric conducting membrane and the catalyst layers may include crosslinking the polymeric chains in the membrane and/or the catalyst layers and optionally also in the interface between the membrane and the catalyst layers. Crosslinking may prevent excessive swelling of the membrane in water, as well as leaching out of polymer chains into the fuel cell product water and mechanical creep of the membrane under compression stress in the fuel cell.

Aspects of the invention may be directed to forming more durable fuel cells by introducing a novel method of crosslinking ionomers. According to some embodiments of the invention, the crosslinking stage is conducted first using a first type of functional groups followed by the functionalization stage that introduce the ion conducting groups to form the ionomer. The outcome of such process is a conducting crosslinked polymer that includes a first type of functional groups forming crosslinking bonds between two ionomer chains and a second type of functional groups that includes ion conducting functional groups. In some embodiments, the crosslinking bonds do not include the ion conducting functional groups. A conducting polymer according to some embodiments of the invention may be included in the membrane, the cathode catalyst layer and/or the anode catalyst layer of either AEM or PEM fuel cells.

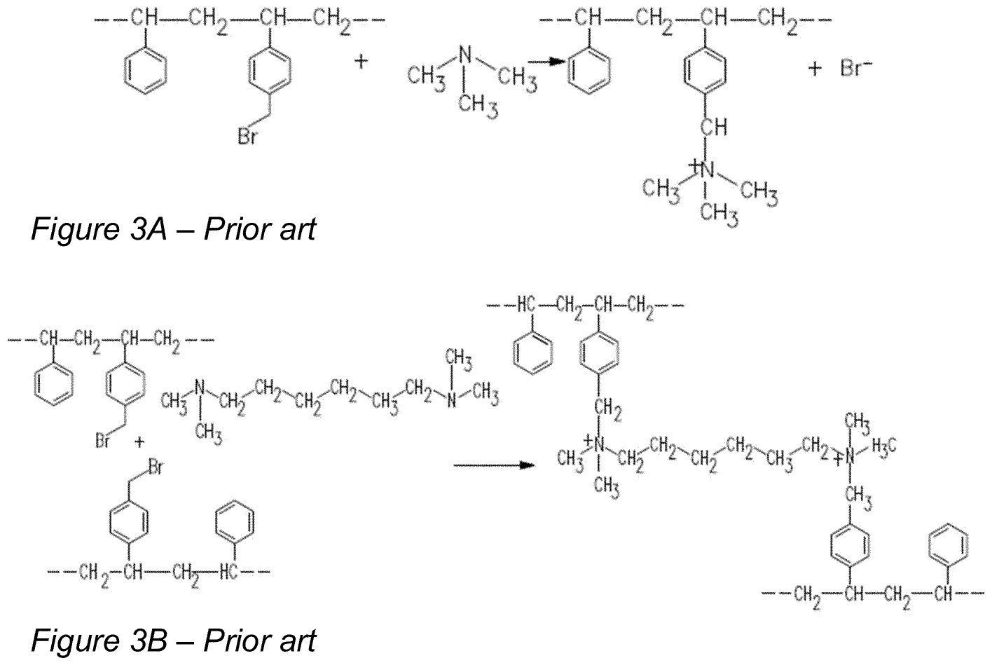

FIGS. 3A and 3B illustrate schematically the prior art amination and crosslinking reactions of styrene-based precursor polymer to form positively charged quaternary ammonium anion conducting groups, and to form linkage between two polymer chains using tetra-methyl-1,6-hexane di-amine (TMHDA) cross linker agent, respectively. Commonly, functionalization of the polymer (e.g., in a precursor form) to form ionomer (i.e., polymer having ion-conducting functional groups) is conducted prior to or during the crosslinking. Accordingly, ionomers are used to form the membrane and/or the catalyst layers are being crosslinked via at least some of the ion-conducting functional groups. For example, in AEM fuel cells, a polymerization reaction may be carried out to yield a non-ion-conducting precursor material with an alkyl halide (for example, Br, Cl or I) functional group (e.g., a precursor polymer), that can later be functionalized to a positively charged quaternary ammonium anion conducting group via the amination reaction: —R—X+N(CH₃)₃→—R—N⁺—(CH₃)₃+X⁻, where R stands for the alkyl- or aryl-based tether functionalization of the polymer monomers, X stands for the halide and N⁺ stands for the ion conducting group. An example for such a reaction is given in FIG. 3A, which demonstrates an amination reaction of a styrene-based polymer precursor to form a positively charged quaternary ammonium anion conducting group.

Following the functionalization of the polymer precursor the ionomer in the membrane and/or catalyst layers can be crosslinked. For example, following the amination reaction, an amination reaction may be performed on the ionomer precursor. The amination reaction forms quaternary ammonium ion conducting group at each of its alkyl halide groups with different halogen groups at two different monomers, yielding a cross-linkage between two chains of the formed cast membrane via the amination reaction: 2[—R—X]+(CH₃)₂N—R′—N(CH₃)₂→—R—N⁺(CH₃)₂—R′—(CH₃)₂N⁺R—+2X⁻, where R′ stand for the carbon chain of the diamine An example for such a reaction is given in FIG. 3B which demonstrates a crosslinking reaction of a styrene based precursor polymer (of FIG. 3A) to form a linkage between two polymer chains using tetramethyl-1,6-hexanediamine (TMHDA) crosslinking agent.

Crosslinking ionomers may yield an anion conducting membrane with crosslinked ionomer chains that is mechanically robust and yet highly conductive. However, ion-conductive ionomers are still sensitive to decomposing either by exposure to OH⁻ or H⁺ ions (the conducting-ion in AEM or PEM fuel cells), by free radicals generated in electrochemical reactions at the electrodes in a FC or electrolyzer, by attack of the polymer by its associated OH⁻ or H⁺ ions, as well as other possible mechanisms. Such a degradation pathway leads to loss of ion conductivity, loss of mechanical strength and loss of water affinity of the membrane or ionomer.

Embodiments of the present invention provide efficient and economical methods and mechanisms for crosslinking of membranes and catalyst layers to yield new chemical structures of membranes and/or of catalyst layers that may improve their stability and degradation durability and thereby provide improvements to the technological field of electrochemical devices. Membranes for electrochemical devices, such as PEM and/or AEM fuel cells, electrolyzers and/or dual devices, and methods of their production are disclosed. The membranes (e.g., an anion conducting membrane) may include crosslinked ionomer comprising two types of functional groups: a first type of functional groups forming crosslinking bonds between two ionomer chains; and a second type of functional groups comprising ion conducting functional groups. In some embodiments, the crosslinking bonds may not include the ion conducting functional groups. Catalyst coated membranes (CCMs) are also disclosed. In such case the membrane may further include at least one catalyst layer attached to at least one side of the membrane to form the catalyst coated membrane (CCM). The at least one catalyst layer may include catalyst nanoparticles and crosslinked ionomer of the catalyst layer comprising two types of functional groups.

Methods of making alkaline exchange catalytic electrodes for electrochemical devices are provided, as well as fuel cells, electrolyzers and dual reversible devices with provided electrodes and/or membrane-electrode assemblies. Methods comprise preparing a catalyst dispersion by mixing catalyst nanoparticles and polymer precursor dispersion in a solvent. The polymer precursor(s) comprise multiple types of monomer units with multiple types of functional groups that include non-cationic functional group(s) and anion-conductive functional group(s). Consecutively, the catalyst dispersion is deposited on a functional substrate and the solvent is evaporated to form a catalyst layer, and then the non-cationic functional group(s) and/or the anion-conductive group(s) are crosslinked to stabilize the catalyst layer. Membrane-electrode assemblies may be formed by the provided methods, and used in various types of electrochemical devices.

Embodiments of the present invention provide efficient and economical methods and mechanisms for preparing crosslinked electrodes and thereby provide improvements to the technological field of electrochemical devices. For example, methods are provided for making electrodes for fuel cells, electrolyzers and for reversible fuel cell/electrolyzer devices. The methods may include preparing a polymer dispersion having monomers with different types of functional groups (as one or more types of monomers), combining the polymer dispersion with catalyst materials so that when the dispersion is deposited on a substrate it forms a catalytically active layer, employing a crosslinking agent configured to chemically bond to the functional groups of the first type when exposed to the polymer chains, to cross-link the polymer precursor within the layer; and optionally depositing additional layer(s) of polymer, optionally with catalyst particles or other additives. The additional layer(s) may also be crosslinked, at the same time or sequentially with other layers, to achieve interfacial bonding between the layers.

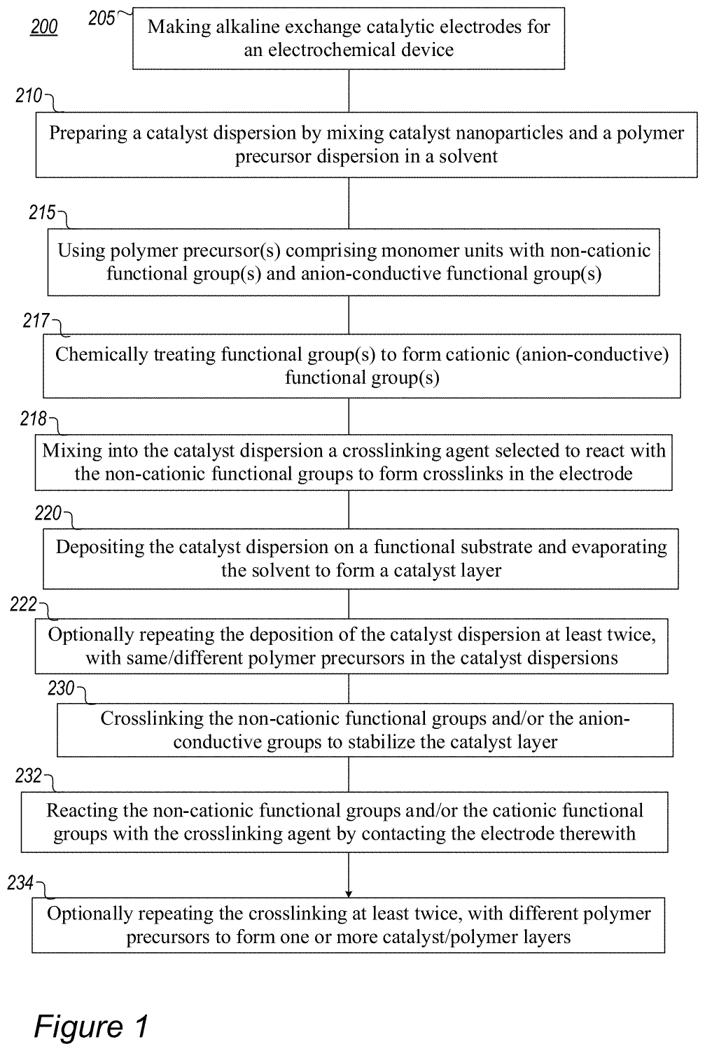

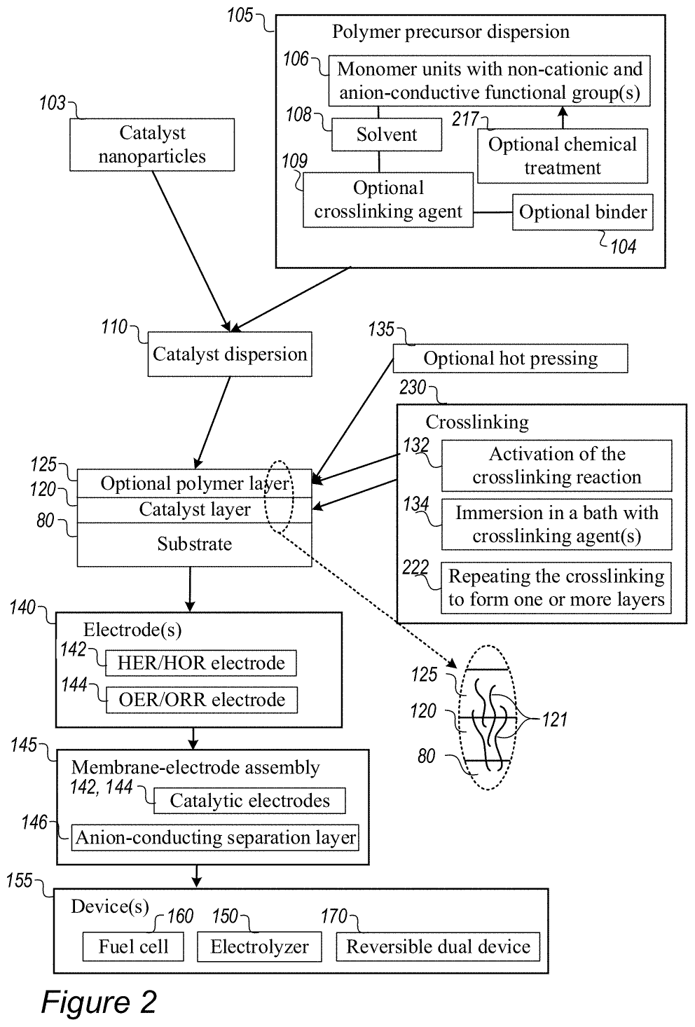

FIG. 1 is a high-level flowchart illustrating a method 200 of making alkaline exchange catalytic electrodes for an electrochemical device (stage 205), according to some embodiments of the invention. FIG. 2 is a high-level schematic block diagram of elements in the preparation of electrodes 140 and devices 155, according to some embodiments of the invention. Method 200 may comprise the following stages, irrespective of their order.

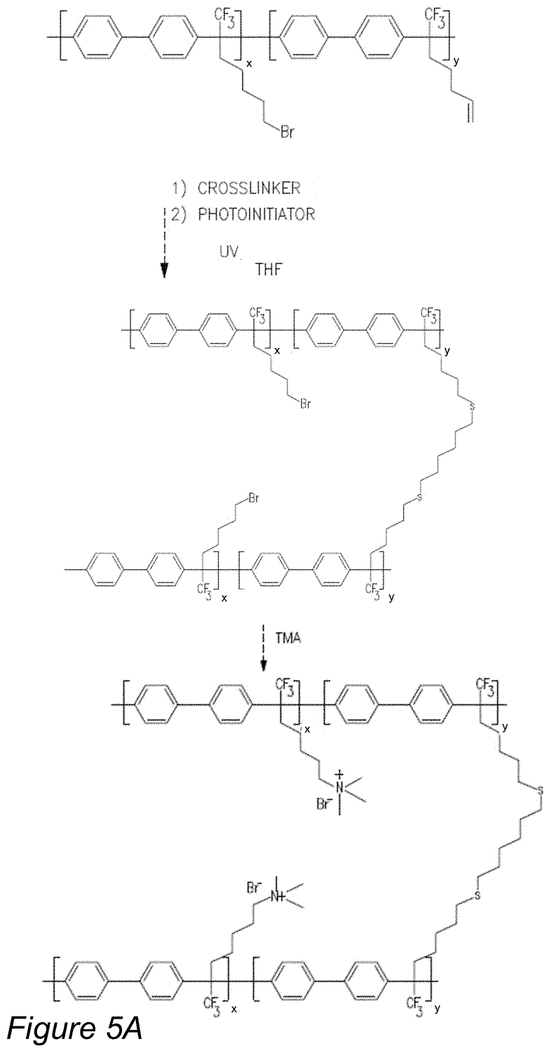

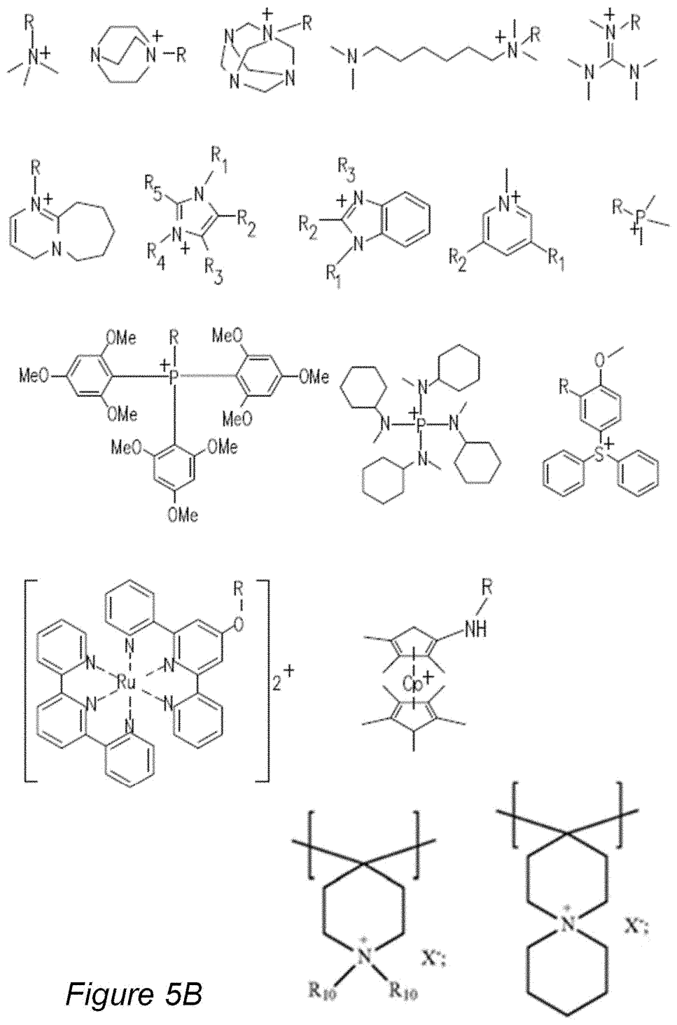

Method 200 comprises preparing a catalyst dispersion 110 by mixing at least one type of catalyst nanoparticles 103 and at least one polymer precursor dispersion 105 in a solvent 108 (stage 210). The polymer precursor(s) may be selected to comprise at least two types of monomer units 106 having respective at least two types of functional groups that comprise at least one non-cationic functional group, and at least one anion-conductive functional group. For example, the anion-conductive functional group(s) may comprise one or more cationic functional group(s) and/or one or more functional group(s) that can be chemically treated to form cationic functional group, with method optionally comprising chemically treating one or more functional group to form the cationic (anion-conductive) functional group(s) (stage 217). Examples for functional groups are disclosed herein, e.g., in FIG. 5B.

Method 200 further comprises depositing catalyst dispersion 110 on a functional substrate 80 and evaporating the solvent to form a catalyst layer 120 (stage 220), and crosslinking at least one of the non-cationic functional groups and/or the anion-conductive groups to stabilize catalyst layer 120 (stage 230).

For example, functional substrate 80 may comprise at least one of an anion exchange membrane, a porous gas diffusion layer and/or porous gas transport layer, and may comprise a mesh for supporting the crosslinked ionomer.

In non-limiting examples, anion-conductive functional group(s) may comprise a quaternary ammonium, and crosslinking 230 may be carried out with dithiol and/or dihalide and/or diamine functional groups.

In non-limiting examples, crosslinking 230 may comprise forming a dithioether type crosslink of the form P—R—S—R′—S—R—P, with S denoting a sulfur atom, and/or an alkyl or aryl crosslink of the form P—R—P, wherein P represents the ionomer chains being crosslinked, R and R′ each being an alkyl or an aryl chain

Preparing of catalyst dispersion (stage 210) may further comprise mixing into the catalyst dispersion a cros slinking agent 109 selected to react with two or more of the non-cationic functional groups to form crosslinks in the electrode (stage 218), and crosslinking (stage 230) may further comprise reacting the at least one of the non-cationic functional groups and/or the cationic functional groups with crosslinking agent 109 by contacting the electrode with the crosslinking agent (stage 232). As non-limiting examples, contacting the electrode with the crosslinking agent may comprise immersing the electrode in a bath containing the crosslinking agent, a dispersion thereof or a solution thereof 134 and activating the crosslinking reaction 132. In non-limiting examples, crosslinking 230 may be carried out by immersing the electrode in a hot bath of dihalide, by adding dihalide to the catalyst dispersion and/or by heating the electrode in solvent vapor.

In certain embodiments, method 200 may comprise repeating the deposition of the catalyst dispersion at least twice, with two or more same and/or different polymer precursors in each of the catalyst dispersions (stage 222) and correspondingly repeating the crosslinking at least twice (stage 234), e.g., with different polymer precursors to form one or more catalyst and/or polymer layers 120, 125. Accordingly, method 200 may be configured to form catalyst layer 120 coated by a polymer layer 125, with the crosslinking carried out to form crosslinked bonds 121 (illustrated schematically) that extend at least across an interface between catalyst layer 120 and polymer layer 125.

As illustrated schematically in FIG. 2, certain embodiments comprise a membrane-electrode assembly 145 comprising two catalytic electrodes (e.g., one or both electrodes 142, 144, optionally with one electrode prepared as disclosed herein and another electrode produced by a different method), separated by an anion-conducting separation layer 146. Certain embodiments comprise fuel cells 160, electrolyzers 150 and/or reversible electrochemical devices 170 functioning alternately as fuel cell and as electrolyzer in a dual configuration. For example, reversible electrochemical device 170 may comprise membrane-electrode assembly 145 with the two catalytic electrodes 1 comprising a hydrogen evolution/oxidation reaction (HER/HOR) electrode 142 comprising a carbon-based gas diffusion electrode (GDE), and an oxygen evolution/reduction reaction (OER/ORR) electrode 144 comprising a metal-based GDE.

A non-limiting example for preparing crosslinked electrodes according to disclosed methods 200 comprises preparing a catalyst ink comprising a polymer dispersion (e.g., in ethanol, 5% w/w) using a polymer containing ternary amine functional groups and anion-conducting, cationic functional groups and combining the polymer dispersion with catalyst particles dispersed in a mixture of H₂O and isopropyl alcohol (e.g., 25%/75% w/w). In a specific non-limiting example, the ratio of catalyst particles to polymer particles was 88%:12% w/w. The combined solids (polymer+catalysts) in the overall dispersion was around 5% w/w. The mixture was stirred by magnetic stirrer for a few minutes then sonicated using a sonicating probe while the container was immersed in an ice bath to limit heating of the slurry.

The electrodes were prepared using fuel cell gas diffusion layers (GDLs) with microporous layers (MPL), which were fixed to a heated table (40° C.), and the polymer/catalyst slurry was deposited onto the GDL by airbrush, yielding a gas diffusion electrode (GDE) having a layer of intermixed catalyst and polymer particles, with a solids' loading of approximately 1 mg/cm². The gas diffusion electrodes were then immersed in liquid dibromohexane (DBH, 96%) at 65° C. for 3.5 hours to crosslink the polymer chains by the solvothermal alkylation reaction, with at least some of the bromo-groups at each end of the DBH reacting with ternary amine groups of two different polymer chains to form a quaternary amine linkage with bromide counterion. The GDEs were then washed several times in distilled water to remove excess DBH. The crosslinked electrode was finally ion-exchanged to bicarbonate form by processes known in the art, and washed multiple times with additional distilled water. Qualitative verification of the crosslinking efficiency was carried out separately using a scratch test on layers deposited according to the disclosed process on a polytetrafluoroethylene (PTFE) substrate, without and with the crosslinking step—to confirm that the crosslinking step almost eliminates the ability to scratch the deposited layer off the PTFE substrate (when deposited without the crosslinking step).

Optionally, additional binder material 104 may be added and used to improve the cohesiveness of catalyst layer 120 and/or electrode 140. In certain embodiments, hot pressing may be used to further consolidate catalyst layer 120 and/or electrode 140 and increase its stability and/or durability, as disclosed below. In certain embodiments, additional polymer layer 125 may be applied to increase the stability and/or durability of electrode 140, and the hot pressing may be applied to polymer layer 125.

Advantageously, the crosslinking may be carried out via functional groups that do not include the anion conducting functional groups, providing a stable crosslinked catalytic layer that include free anion conducting functional groups. Separation of crosslinking functionality and anion conducting functionality into two or more different types of functional groups allows for handling layer strength and cohesivity independently from the catalytic layer's functionality of anion conductivity, thus enabling the optimization of both functions together to improve electrodes for fuel cells, electrolyzers and dual reversible devices.

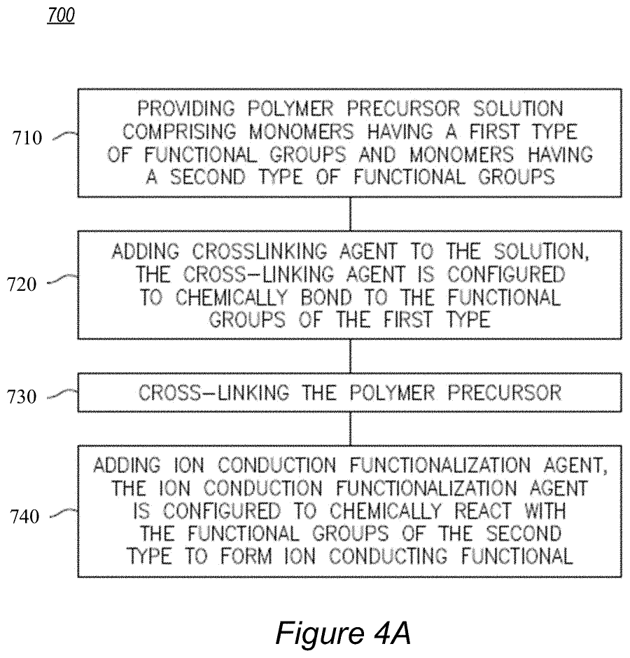

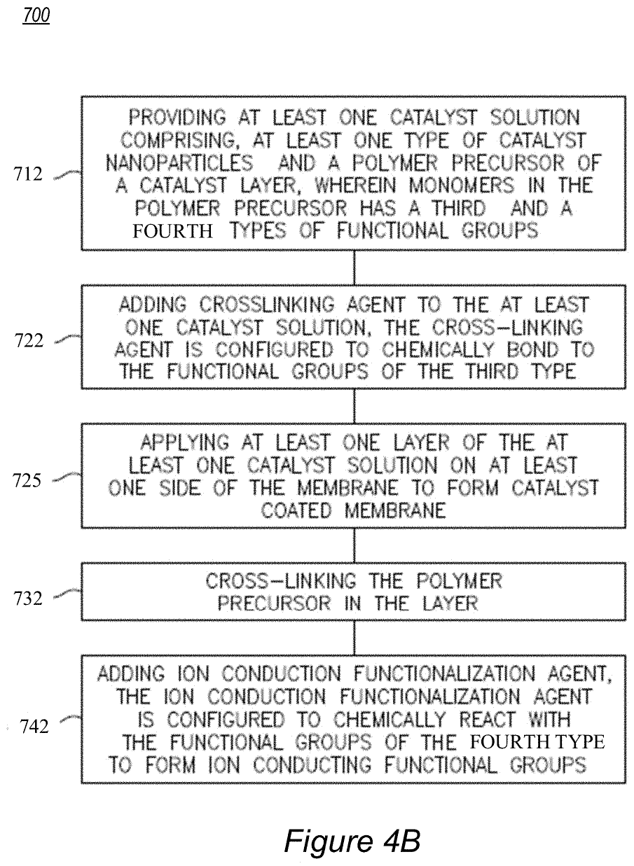

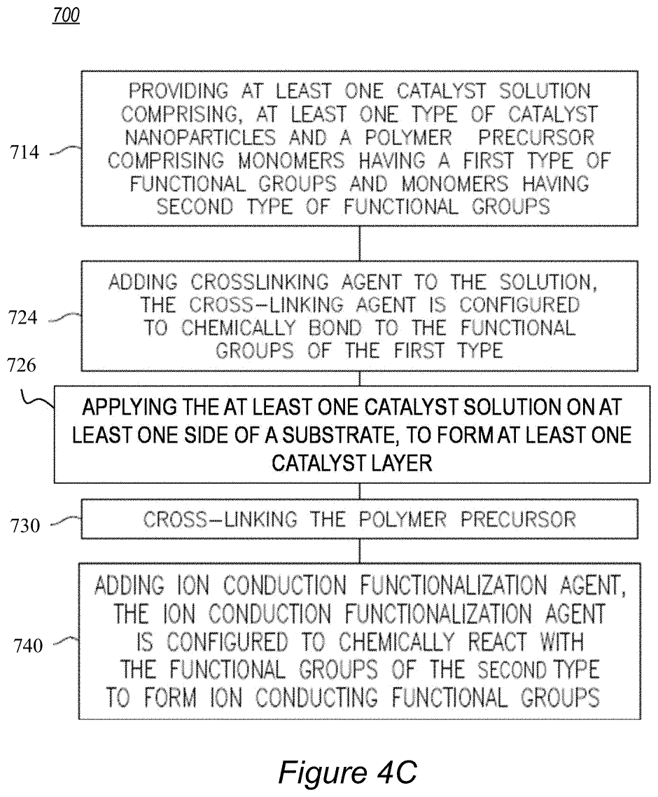

FIGS. 4A-4C provide schematic examples for methods 700 including polymerization, crosslinking and functionalization reactions, according to some embodiments of the invention. FIG. 5A provides a non-limiting example for polymerization, crosslinking and functionalization reactions according to some embodiments of the invention. FIG. 5B provides non-limiting examples for ion conducting functional groups according to some embodiments of the invention.

Reference is now made to FIG. 4A which is a flowchart of a method 700 of making a membrane according to some embodiments of the invention. In step 710, polymer precursor solution comprising monomers having a first type of functional groups and monomers having a second type of functional groups may be provided. In some embodiments, the first and second types of functional groups are different from each other. In some embodiments, providing the polymer precursor solution may include providing monomer solution and/or conducting polymerization process to the monomers. For example, providing the polymer precursor solution may include providing bi-phenyl backboned with two functional groups: an alkene tether (as the first functional group) and alkyl halide (as the second functional group), as illustrated schematically in FIG. 5A. As should be understood by a person skilled in the art the precursors and polymers in FIG. 5A are given as examples only and the invention as a whole is not limited to a specific polymeric chemistry. For example, ratios x and y are illustrated schematically for the quantitative ratios between the first and second functional groups, respectively, with x ranging between 30% and 90% and y correspondingly between 70% and 10%, e.g., x may equal any of 30%, 40%, 50%, 60%, 70%, 80%, 90%, e.g., 85%, or intermediate values, and y may equal respectively any of 70%, 60%, 50%, 40%, 30%, 20%, 10%, e.g., 15%, or intermediate values. The crosslinker and the photoinitiator may be used at different relative amounts, e.g., the crosslinker may be used between 0.1 and 0.3 eq (e.g., any of 0.1, 0.15, 0.2, 0.25, 0.3 eq or intermediate values) and the photoinitiator may be used between 0.01 and 0.1 eq (e.g., any of 0.01, 0.05, 0.1 eq or intermediate values). UV illumination may be applied for 5 to 60 minutes (e.g., any of 5, 10, 20, 30, 40, 50, 60 minutes or intermediate values). TMA may be applied in a range of concentrations, e.g., between 5% w/w and 100% w/w (or any intermediate value).

In step 720, a crosslinking agent may be added to the solution, the cross-linking agent may be configured to chemically bond to the functional groups of the first type. For example, 1,6-hexanedithiol cross linker agent (a dithiol crosslinking agent) may be added to the biphenyl backboned precursor to cause two monomers functionalized with alkene tether functional group to form cross linking or bridge between two precursor polymer chains to form a dithioether, as shown in FIG. 5A. In some embodiments, other crosslinking agents may include for example, one of a group consisting of: hydrocarbon chains, sulfur groups, siloxy groups, halide groups, N-hydroxybenzotriazole groups and Azide groups and the like.

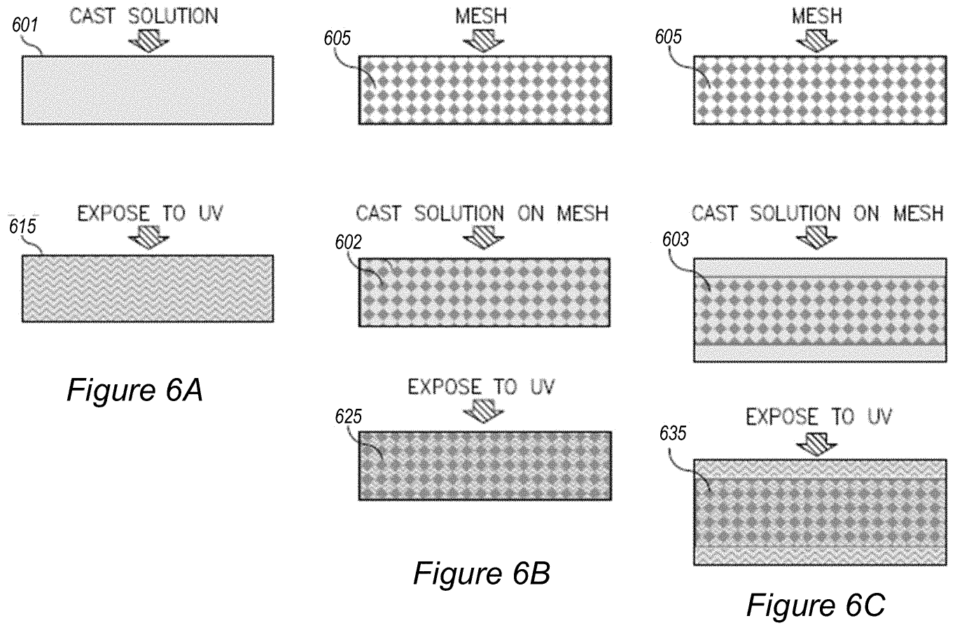

In some embodiments, the polymer precursor may be given a shape of a membrane, for example, by casting the polymer precursor solution and the crosslinking agent to form the membrane. In some embodiments, other fabrication methods may be conducted, for example, printing the polymer precursor solution on top of a substrate (e.g., a catalyst layer or any other substrate). In some embodiments, the polymer precursor solution may be inserted into a mesh to form a supported membrane. Some illustrations of membranes in various production stages according to embodiments of the invention are given and discussed with respect to FIGS. 6A-6C.

In step 730, the polymer precursor may be crosslinked, as presented in FIG. 5A. The polymer precursor, e.g., in the form of a membrane, may be exposed to ultraviolet (UV) radiation or to any other initiation source to activate the crosslinking process, possibly in the presence of a suitable initiator.

In step 740, ion conduction functionalization agent may be added to the membrane, the ion conduction functionalization agent may be configured to chemically react with the functional groups of the second type to form ion conducting functional groups, for example, the ion conducting groups illustrated in FIG. 5B. For example, trimethylamine (TMA) may be added to react with the alkyl halide to form a quaternary ammonium type of conducting functional group as illustrated in FIG. 5A. The final microstructure of the membrane that is illustrated in FIG. 5A may include a first type of functional group containing dithioether crosslink groups of the form P—R—S—R′—S—R—P and a second type of functional group contacting quaternary ammonium conducting functional groups, as illustrated, or any anion conducting group. In another example, the final microstructure of a membrane according to some embodiments of the invention may include a first type of functional group containing alkyl or aryl crosslink of the form P—R—P, where P represents the ionomer chains being crosslinked, R and R′ being alkyl or aryl chain, and S being a sulfur atom and the second type may be any anion conducting group.

In some embodiments, the above chemical microstructure may be selected to ensure that the selected crosslinking group is stable to alkaline conditions. Therefore, the functional group that is to be crosslinked should not consist of quaternary ammonium, phosphonium or other cationic groups that, whilst they may act as ion exchange units and are thus beneficial to the performance of an alkaline exchange membrane, are susceptible to decomposition under alkaline conditions, especially if also accompanied by low hydration levels. Accordingly, a method of producing an anion conducting membrane according to some embodiments of the invention may include choosing a different chemical nature to the crosslinked group from the remaining functional groups that may be converted in a separate (earlier or later) step to anion conducting groups.

In some embodiments, the benefits of using the selected chemistries may include using the cross-linkable functional group that may be generated from a standard, unmodified precursor polymer with only the alkyl halide functional group via a halide elimination reaction to form the alkene.

In some embodiments, at least some of the solvent in the precursor solution may be evaporated to form a drier membrane prior or after adding the functionalization agent. The membrane may be dried according to any known method.

In some embodiments, additional catalyst layers may be applied on one or two sides of the membrane to form a catalyst coated membrane (CCM). In some embodiments, at least one catalyst solution may be provided. The at least one catalyst solution may include at least one type of catalyst nanoparticles and a polymer precursor of a catalyst layer, such that monomers in the polymer precursor have a third and a fourth types of functional groups different from each other. In some embodiments, the third and a fourth types of functional groups may be the same as or different from the first and second functional groups respectively.

In some embodiments, a crosslinking agent may be added to the at least one catalyst solution, the cross-linking agent may be configured to chemically bond to the functional groups of the third type. In some embodiments, the crosslinking agent may include for example, one of a group consisting of: hydrocarbon chains, sulfur groups, halide groups, siloxy groups, N-hydroxybenzotriazole groups and azide groups and the like. In some embodiments, the catalyst solution may include similar functional groups as the membrane, as disclosed herein above.

In some embodiments, the at least one catalyst solution may be applied on at least one side of the membrane to form a catalyst coated membrane (CCM). The catalyst solution may be printed, cast, sprayed and the like on one or both sides of the membrane. In some embodiments, a first catalyst solution that include the third functional group and the crosslinking agent may be applied on one side of the membrane and a second catalyst solution may be applied on a second side of the membrane. In some embodiments, the second catalyst solution may not include the crosslinking agent. In some embodiments, the CCM may be crosslinked using any known method (e.g., UV radiation, heat etc.). In one embodiment, when two catalyst layers that include crosslinking agent are applied, both sides of the membrane may be crosslinked. In another embodiment, if only the first catalyst layer includes crosslinking agent (e.g., the anode catalyst layer) and the second catalyst does not (e.g., the cathode catalyst layer) only the first catalyst layer may be crosslinked.

In some embodiments, crosslinking the polymer precursor in the membrane and the crosslinking the polymer precursor in the at least one catalyst layer may be conducted in separate steps. In such case, the at least one catalyst layer may be applied to a crosslinked fully functionalized ion conducting membrane. In some embodiments, the cross-linking of the polymer precursor in the membrane and the crosslinking of the polymer precursor in the at least one layer may be conducted simultaneously. In such case the at least one catalyst layer may be applied to the membrane directly after forming the membrane (e.g., casting, printing and the like) and the crosslinking (e.g., application of UV radiation) may be conducted simultaneously on the entire CCM. In some embodiments, the first type of functional group in the membrane precursor may be the same as the third type functional group in the catalyst layer, such that upon conducting simultaneous crosslinking process, crosslinking chemical bond may be formed also in the interface between the membrane and the at least one catalyst layer. For example, the first and third type of functional groups may include dithioether crosslink groups of the form P—R—S—R′—S—R—P. In another example, the first type and third type of functional groups containing alkyl or aryl crosslink of the form P—R—P, where P represents the ionomer chains being crosslinked, R and R′ being alkyl or aryl chain, and S being a sulfur atom.

In some embodiments, following the crosslinking process ion conducting functionalization agent may be added to the CCM. In some embodiments, the ion conducting functionalization agent may configured to chemically react with the functional groups of the fourth types to form ion conducting functional groups (e.g., anion conducting function group), as discussed with respect to step 740. In some embodiments, the ion conducting functionalization agent may be added only to the at least one catalyst layer when the membrane is already ion-conducting. In some embodiments, the ion conducting functionalization agent may be added simultaneously to the membrane and the at least one catalyst layer after a simultaneous crosslinking process to form ion-conductivity in all parts of the CCM.

In some embodiments, forming a CCM may be conducted using any depositing process, such as spraying or printing (e.g., die coating, doctor blade, silk printing and the like). FIG. 4B provides a non-limiting example for a process that includes repeating steps 710 and 720 of the method of FIG. 4A. The process may further include providing a first catalyst solution comprising, first catalyst nanoparticles and a first polymer precursor that includes monomers having a third and a fourth types of functional groups different from each other (stage 712) and adding a crosslinking agent to the first catalyst solution (stage 722). The cross-linking agent may be configured to chemically bond to the functional groups of the third type. The process may further include providing a second catalyst solution that includes second catalyst nanoparticles and a second polymer precursor comprising monomers having a fifth and a sixth types of functional groups different from each other and adding the crosslinking agent comprising hydrocarbon chains to the second catalyst solution, the crosslinking agent being configured to chemically bonded to the functional groups of the fifth type.

In some embodiments, the process may further include deposing (e.g., printing, spraying and the like) the first catalyst solution on a substrate to form a first catalyst layer; depositing the polymer precursor solution on top of the first catalyst layer to form the membrane (stage 725) and depositing the second catalyst solution on the deposited membrane to form a second catalyst layer. Following the deposition process the deposited CCM may be crosslinked simultaneously (stage 732), using any known method. Alternatively, the crosslinking process of the membrane and the first and the second catalyst layers may be conducted separately after each deposition step. After the completion of the crosslinking process a functionalization agent may be added to the CCM (stage 742). In some embodiments, the functionalization agent may be configured to chemically react with the functional groups of the second, and fourth and sixth types to form ion conducting functional groups.

In some embodiments, in order to form crosslinking in the interface between the deposited membrane and the deposited first and second catalyst layer, the first, third and fifth functional groups may be the same.

Reference is now made to FIG. 4C which is a flowchart of method 700 of forming a catalyst layer on a substrate according to some embodiments of the invention. In step 714, at least one catalyst solution may be provided. The catalyst solution may include, at least one type of catalyst nanoparticles and a polymer precursor comprising monomers having a first type of functional groups and monomers having second type of functional groups, wherein the first and second types of functional groups are different from each other. In some embodiments, the catalyst nanoparticles may include at least one of a group consisting of: active metal nanoparticles, active metal nanoparticles supported on carbon nanoparticles and active metal nanoparticles supported on non-active metal nanoparticles.

In some embodiments, providing the polymer precursor may include providing monomer solution and/or conducting polymerization process to the monomers. For example, a polymerization reaction may be carried out to yield a non-ion-conducting precursor material with an alkyl halide (for example, Br, Cl or I) functional group to form the precursor polymer. The polymerization reaction may further introduce adding styrene-based precursor polymer to form the polymer chains using di-vinyl chemistry. In such case the first and second types of functional groups are the double bond and the alkyl halide, as presented in FIG. 5A.

In yet another example, providing the polymer precursor may include providing bi-phenyl backboned with two functional groups alkene tether (the first functional group) and alkyl halide (the second functional group). It is noted that disclosed precursors and polymers are given as non-limiting examples and that in certain embodiments alternative polymeric chemistry may be used.

In step 724, cross-linking agent may be added to the at least one catalyst solution, the crosslinking agent being configured to chemically bond to the functional groups of the first type, as discussed above with respect to step 720.

In step 726, the at least one catalyst solution may be applied on at least one side of a substrate, to form at least one catalyst layer. In some embodiments, applying the catalyst layer may include, depositing, printing, casting, etc., the catalyst solution on top of the substrate. In some embodiments, the substrate may be selected from a group consisting of: a membrane, a supported membrane, a gas diffusion layer (GDL) and micro porous layer (MPL).

In step 730, the at least one catalyst layer may be crosslinked as discussed herein. In step 740 an ion conducting functionalization agent can be added to the catalyst layer. The ion conducting functionalization agent may be configured to chemically react with the functional groups of the second type to form ion conducting functional groups, as discussed herein.

FIGS. 6A-6C, 7A-7C, 8A and 8B are high-level schematic illustration of membranes and CCMs, according to some embodiments of the invention.

Reference is now made to FIGS. 6A-6C which are illustrations of membranes according to some embodiments of the invention during various fabrication stages. Membranes 601, 602 and 603 may be fabricated using any method for applying a polymer precursor known in the art, for example, casting, printing and the like. Membrane 601 may be formed by applying a polymer precursor solution on top of a substrate. The polymer precursor solution may include monomers having a first type of functional groups and monomers having a second type of functional groups wherein the first and second types of functional groups are different from each other. The polymer precursor solution may further include a cros slinking agent that is configured to be chemically bonded to the first type of functional groups. Membranes 602 and 603 may be formed by inserting the polymer precursor solution to a mesh 605 in two options, when the polymer precursor covers substantially the entire mesh, as illustrated in FIG. 6B, and when the polymer precursor expands beyond the mesh to form thin layers on surfaces of the mesh, as illustrated in FIG. 6C.

Membranes 601, 602 and 603 may be crosslinked, for example, using UV radiation, and further be exposed to ion conduction functionalization agent, the ion conduction functionalization agent may be configured to chemically react with the functional groups of the second type to form ion conducting functional groups.

The outcome of the process may include membranes such as membranes 615, 625 and 635. Each one of membranes 615, 625 and 635 may include crosslinked ionomer that includes two types of functional groups, a first type of functional groups forming crosslinking bonds between two ionomer chains and a second type of functional groups comprising ion conducting functional groups for example, the ion conducting functional groups of FIG. 5B. In some embodiments, the crosslinking bonds may not include the ion conducting functional groups.

In some embodiments, the first type of functional groups forming the crosslinking bonds may include, for example, hydrocarbon chains, sulfur group —S—S—S— formed using vulcanization, siloxy group —Si—O—Si— formed using silanization, N-hydroxybenzotriazole group —N═C═N— formed using carbodiimide, azide group —N═N═N— and the like.

In some embodiments, membranes 625 and 635 may further include mesh 605 for supporting the crosslinked ionomer. In some embodiments, the ionomer may be crosslinked also to the mesh when the mesh includes the required functional groups. The required functional groups may be similar to the first type of functional groups.

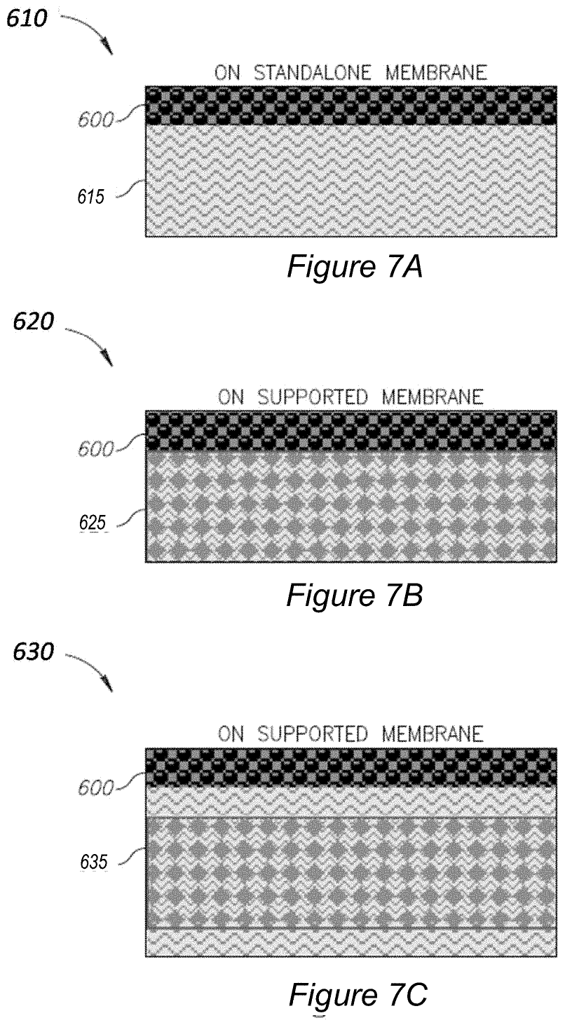

Reference is now made to FIGS. 7A-7C which are illustrations of CCMs according to some embodiments of the invention. CCMs 610, 620 and 630 may include membranes 615, 625 and 635 coated with at least one catalyst layer 600 attached to at least one side of membranes 615, 625 and 635. Catalyst layer 600 may include catalyst nanoparticles and crosslinked ionomer of the catalyst layer that include two types of functional groups, a third type of functional groups forming cross-linking bonds between two ionomer chains of the catalyst layer and a fourth type of functional groups comprising ion conducting functional groups. In some embodiments, the crosslinking bonds may not include the ion conducting functional groups. In some embodiments, the first and third types of functional groups are the same. In some embodiments, in such case the same crosslinking bonds are formed across the interface between membranes 615, 625 and 635 and at least one catalyst layer 600.

In some embodiments, the fourth ion-conducting groups and the second ion-conducting groups may be the same or may be different, for example, the ion-conducting groups shown in FIG. 5B.

In some embodiments, a first catalyst layer 600 may be attached to a first side of the catalyst coated membrane 610, 620 and 630 may include first catalyst nanoparticles and the crosslinked ionomer of the catalyst layer. In some embodiments, a second catalyst layer (not illustrated) may be attached to a second side of the catalyst coated membrane that may include non-crosslinked ionomer and a second catalyst nanoparticles.

The following non-limiting example (Example 1) illustrates the making a standalone membrane (e.g., membrane 615). The example includes the following steps:
1. To a container equipped with stirrer was added (e.g., 300 mg) precursor polymer of 60 kDa in molecular size/weight (range: 10 kda to 100 kDa) of Bi-Phenyl backboned (e.g., as illustrated in FIG. 6A) made of 85% monomers functionalized with alkyl halide (Br or Cl) and 15% monomers functionalized with alkene tether—see FIG. 7A (range: 95%:5% to 75%:25%).
2. 9.0 ml of tetrahydrofuran (THF) solvent, or other solvents, was added at a solvent volume to precursor polymer weight ratio of 3 ml/100 mg (range: 2 ml/100 mg to 6 ml/100 mg).
3. The solution was stirred for 3 hr (Range: 2 hr to 6 hr) until the precursor polymer was fully dissolved and a uniform dark yellow viscous solution was formed.
4. 0.0184 ml of 1,6-Hexanedithiol cross linker (XL) agent was added at a eq. mole cross linker agent to precursor average monomer ratio (since in the precursor 85% of monomers are functionalized with alkyl halide and 15% are functionalized with alkene tether) of 0.15 mole/1 mole (range: 0.05 mole/1 mole to 0.25 mole/1 mole).
5. 7.33 mg of Benzophenone photo-initiator was added at a eq. mole photo-initiator to cross linker agent ratio of 1 mole/3 mole (range: 1 mole/1 mole to 1 mole/5 mole).
6. The solution was stiffed for 10 min (range 5 min to 30 min) for forming a fully uniform solution.
7. The formed solution was casted onto a flat glass surface (9 cm×9 cm square) at a volume solution to area of 1 ml/9 cm² (range: 1 ml/2 cm² to 1 ml/20 cm²) and cover glass to avoid solvent evaporation.
8. The cast solution was exposed to 365 nm UV radiation (range: 200 nm to 400 nm) for 20 min (range 1 min to 40 min) to create cross linking of precursor polymer inside the casted solution.
9. The solvent was evaporated during 48 hr (range: 12 hr to 96 hr) at 20° C. temperature (range: 20° C. to 100° C.) to form a dry precursor membrane (e.g., a membrane that is not functionalized with ion conducting functional groups) made of UV cross linked precursor polymer—see, e.g., FIG. 6B.
10. The result was approximately ˜30 μm (range: 10 μm to 50 μm) precursor membrane ready for functionalization with ion conducting function groups, illustrated in FIG. 5B.

The following non-limiting example (Example 2) illustrates the making of a mesh supported standalone membrane (e.g., membranes 625 and 635). The example includes the following steps: Steps 1-6 were conducted substantially the same as in Example 1.
7. The formed solution was die-coated a flat ˜30 μm (range: 10 μm to 50 μm) mesh support surface in the form of 9 cm×9 cm square at a volume solution to area of 1 ml/9 cm2 (Range: 1 ml/2 cm2 to 1 ml/20 cm2) and cover surface to avoid solvent evaporation.
8. The cast mesh support was exposed to 365 nm UV radiation (range: 200 nm to 400 nm) for 20 min (range: 1 min to 40 min) to create crosslinking of precursor polymer inside the casted solution.
Steps 9 and 10 were conducted substantially the same as in Example, 1.

The following non-limiting example (Example 3) illustrates the forming of a catalyst layer. The example includes the following steps: Steps 1-6 were conducted substantially the same as in Example 1.
7. A catalyst material and/or support material and/or supplementary material (e.g., solid materials) at solid materials was added to precursor polymer weight ratio of 85 wt %/15 wt % (Range: 95 wt %/5 wt % to 50 wt %/50 wt %).
8. The solution was stirred until receiving a uniform catalyst ink.
9. The catalyst was deposited on top a flat membrane and/or gas diffusion layer (GDL) surface (9 cm×9 cm square) at a volume solution to area of 1 ml/9 cm² (range: 1 ml/2 cm² to 1 ml/20 cm²) and cover surface to avoid solvent evaporation.
10. The catalyst layer was exposed to 365 nm UV radiation (range: 200 nm to 400 nm) for 20 min (range 1 min to 40 min) to create cross linking of precursor polymer inside the catalytic layer.
11. The solvent was evaporated for 48 hr (range: 12 hr to 96 hr) at 20° C. temperature (range: 20° C. to 100° C.) to form dry catalyst layer.
12. The result was approximately ˜30 μm (range: 10 μm to 50 μm) precursor catalyst layer ready for functionalization with ion conducting functional groups, illustrated, e.g., in FIG. 5B.

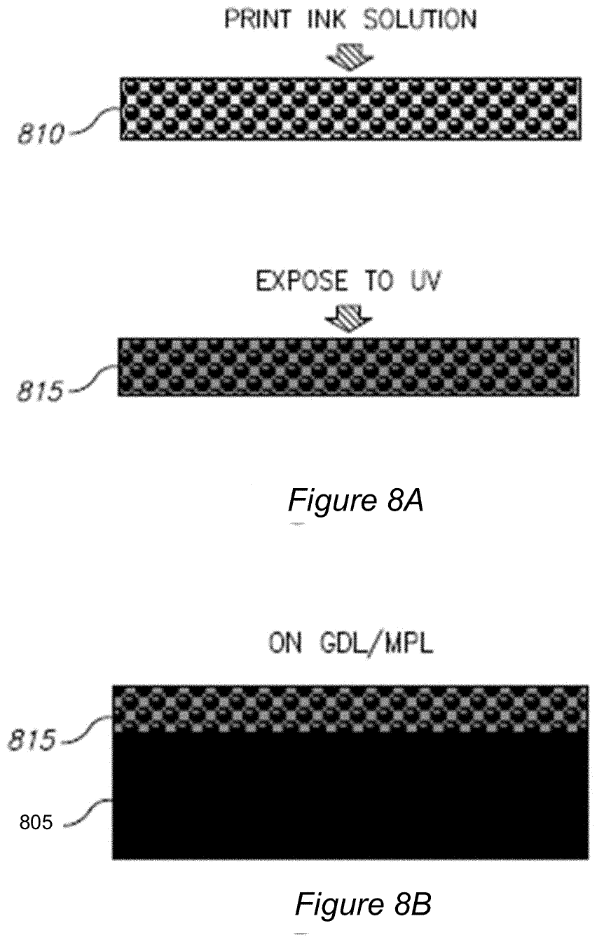

Reference is now made to FIGS. 8A and 8B with are illustration of catalyst layers for a membrane fuel cell according to some embodiments of the invention. Layer 810 may be applied on top of a substrate 805 and may be crosslinked and functionalized to form layer 815, as discussed herein with respect to method 700. Layer 815 may include catalyst nanoparticles and cross-linked polymer ionomer that include two types of functional groups. The two types of functional groups may include a first type of functional groups forming cross-linking bonds between two ionomer chains and a second type of functional groups that include ion conducting functional groups for example, the ion conducting functional groups of FIG. 5B. In some embodiments, the crosslinking bonds may not include the ion conducting functional groups.

In some embodiments, the first type of functional groups forming the crosslinking bonds may include, for example, hydrocarbon chains, Sulfur group —S—S—S— formed using vulcanization, siloxy group —Si—O—Si— formed using silanization, N-hydroxybenzotriazole group —N═C═N— formed using carbodiimide, azide group —N═N═N— and the like.

Disclosed catalyst layers 120 may comprise one or more catalyst layers 600, 815 or any of the catalyst layers disclosed herein; and membrane assemblies 145 may comprise one or more catalyst coated membrane 610, 620 and 630, or any of the membrane assemblies disclosed herein. Disclosed catalyst layers 120, electrodes 140 and membrane assemblies 145 may be used in fuel cells 160, electrolyzers 150 and dual devices 170, and be configured correspondingly. Any of the configurations of electrodes 140 (e.g., hydrogen oxidation, hydrogen evolution, oxygen reduction and/or oxygen evolution electrodes) may be used in corresponding devices, such as alkaline exchange membrane fuel cells 160, electrolyzers 150 or reversible devices 170 including both fuel cell and electrolyzer functionalities, and configured to operate alternately in either operation mode. Additional binder material and optionally brief hot pressing may also be applied to stabilize respective electrodes 140 and/or membrane assemblies 145 to increase their durability, as disclosed herein.

Embodiments of the present invention provide efficient and economical methods and mechanisms for configuring and operating reversible fuel cell/electrolyzer systems and thereby provide improvements to the technological field of energy storage and delivery. Self-refueling power-generating systems and methods of configuring them are provided, which enable operation in a self-sustained manner, using no external resource for water, oxygen or hydrogen. The systems and methods determine the operation of reversible device(s) in fuel cell or electrolyzer mode according to power requirements and power availability, supply oxygen in a closed circuit, compressing received oxygen in the electrolyzer mode, and supplying water or dilute electrolyte in a closed circuit in conjunction with the closed oxygen supply circuit by separating oxygen produced by the reversible device(s) in the electrolyzer mode from the water or dilute electrolyte received from the reversible device(s).

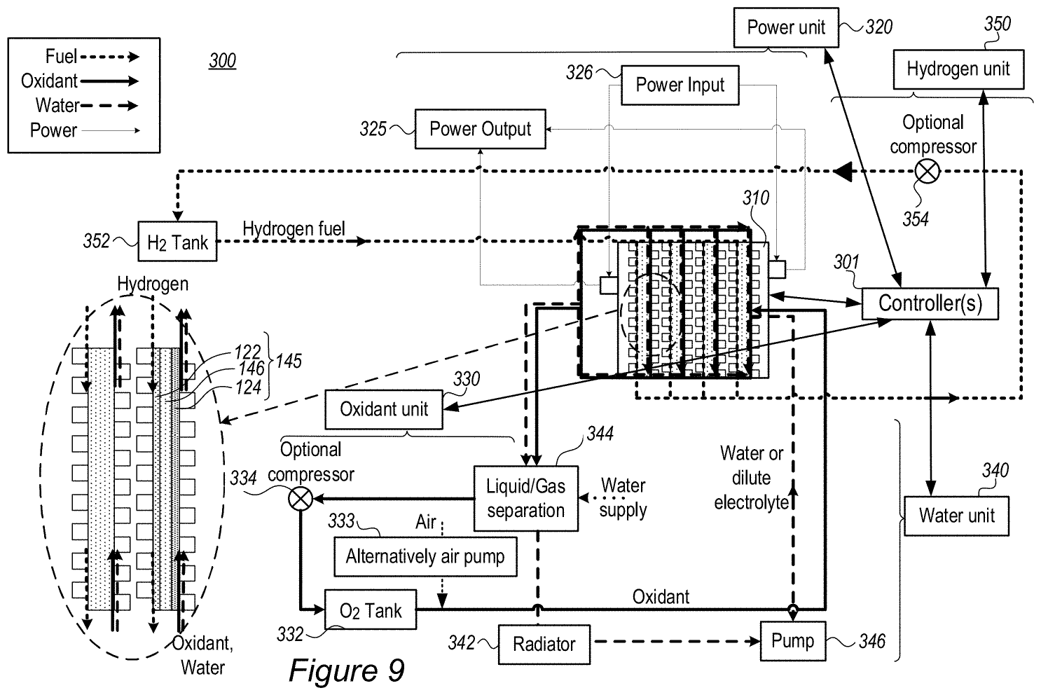

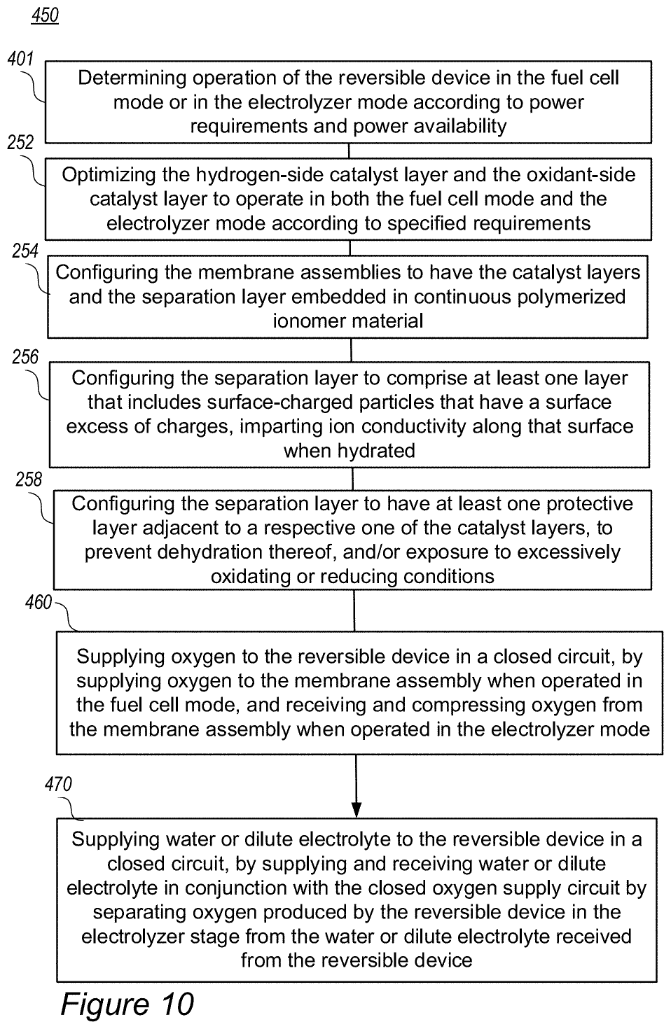

FIG. 9 is a high-level schematic illustration of a self-refueling power-generating system 300 with reversible devices 310, according to some embodiments of the invention. FIG. 10 is a high-level flowchart illustrating a method 450 of configuring a power-generating system to be self-refueling and self-sustaining, according to some embodiments of the invention.

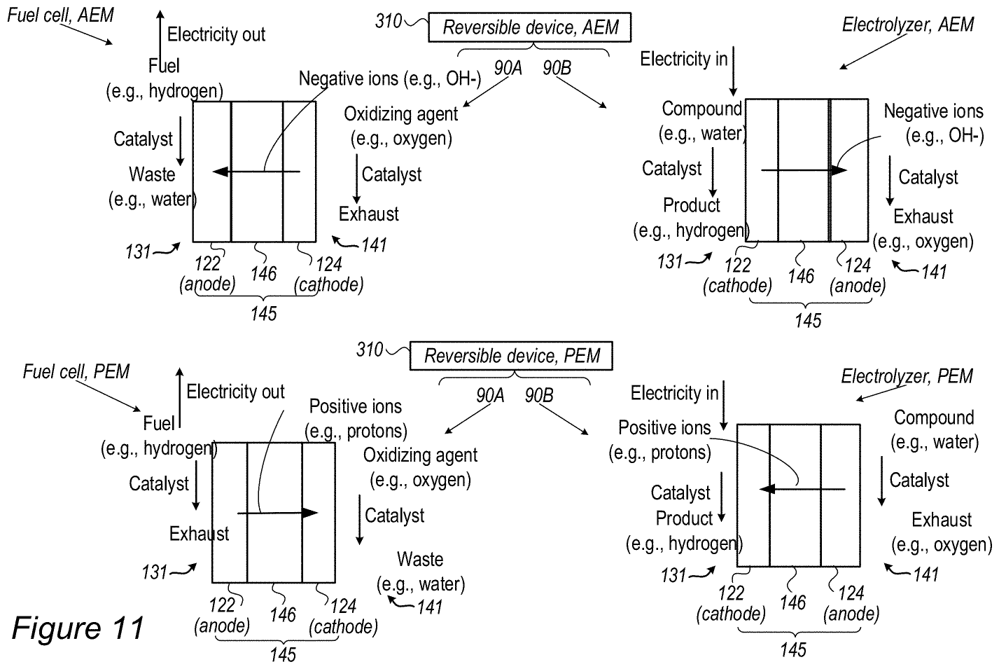

As illustrated schematically in FIG. 9, self-refueling power-generating system 300 comprises one or more reversible device 310 comprising a stack of one or more electrochemical cells with respective membrane assemblies 145. Reversible device 310 is configured to be operated alternately as a fuel cell in a fuel cell mode and as an electrolyzer in an electrolyzer mode (see FIG. 11). Each of membrane assemblies 145 has a hydrogen-side (131) catalyst layer 120 on electrode 144 configured to catalyze hydrogen oxidation in the fuel cell mode and to catalyze hydrogen formation (from water electrolysis) in the electrolyzer mode and an oxidant-side (141) catalyst layer 120 on electrode 142 configured to catalyze oxygen reduction in the fuel cell mode and to catalyze oxygen formation (from water electrolysis) in the electrolyzer mode. Catalyst layers 120 on electrodes 144, 142 may be arranged in pairs and be separated by a separation layer 146 that allows ion transfer therethrough, anions in AEM configurations and protons in PEM configurations. Separation layer 146 may comprise a single layer, a composite layer, or multiple layers, each of which may be simple or composite, as disclosed below. System 300 further comprises one or more controller 301 configured to determine operation of reversible device 310 in the fuel cell mode or in the electrolyzer mode. The stack may comprise a single bifunctional stack with a plurality of electrochemical cells with respective membrane assemblies 145, that functions, as a single stack, in both fuel cell and electrolyzer operation modes. In various embodiments, the stack may comprise two, three, five, ten, twenty, fifty or more cells, or an intermediate number of cells.

Membrane assemblies 145 may comprise single layered or multi-layered solid state polymer membranes. For example, polymer membranes may be based on an ion-conducting polymer, and be able to transport water and anions and/or cations from one electrode to the other during operation. Membrane assemblies 145 may comprise (i) at least one catalyst layer comprising, on an oxygen side 141 of membrane assembly 145: oxygen generating catalyst layer(s), oxygen reducing catalyst layer(s) and/or bifunctional catalyst layer(s) capable of oxygen generation as well as oxygen reduction; and (ii) at least one catalyst layer comprising, on a hydrogen side 131 of membrane assembly 145: hydrogen generating catalyst layer(s), hydrogen oxidizing catalyst layer(s) and/or bifunctional catalyst layer(s) capable of hydrogen generation as well as hydrogen oxidation.

It is noted that either of catalyst layers 120 on electrodes 122, 124 may comprise one or more materials, and may include different materials to support the opposite catalytic reactions. For example, catalyst layer 120 of oxygen-side electrode 142 on oxygen side 141 may comprise one or more materials to generate oxygen and one or more same or different materials to reduce oxygen, while catalyst layer 120 of hydrogen-side electrode 144 on hydrogen side 131 may comprise one or more materials to generate hydrogen and one or more same or different materials to oxidize hydrogen. It is further noted that catalyst materials for one direction of operation (fuel cell mode 90A or electrolysis mode 90B) may be more efficient than the catalyst materials for the opposite direction of operation, depending, e.g., on the expected operation profile of reversible system 300 (e.g., on the required power supply rate and/or on the hydrogen refilling rate). It is further noted that other than in prior art such as U.S. Patent Application Publication No. 20130146471, in certain embodiments multiple catalyst materials may be integrated in a single respective catalyst layer that is operative in both reaction directions, in both fuel cell mode 90A and electrolysis mode 90B, and are not separated into two or more distinguishable layers. Examples for catalyst materials are provided below.

Self-refueling power-generating system 300 further comprises an oxidant unit 330 configured to supply oxygen or air to reversible device 310 when operated in fuel cell mode, and optionally receive oxygen from reversible device 310 when operated in electrolyzer mode. Optionally, oxidant unit 330 may comprise an oxygen tank 332 for storing oxygen and may comprise a compressor 334 for compressing oxygen received from AEM device 310 into oxygen tank 332. Alternatively, oxygen compression may be provided by AEM device 310 during its operation as an electrolyzer in the electrolyzer mode. Supplying pure oxygen to oxygen-side electrode 142 during power generation in fuel cell mode may increase the efficiency of system 300 as well as simplify system 300 by making use of the oxygen produced together with hydrogen generation in the electrolyzer mode—possibly yielding a closed oxygen circuit. If needed, any of an additional pump, a CO₂ filter and/or a humidification unit may be included in the closed oxygen circuit.

Self-refueling power-generating system 300 further comprises a hydrogen unit 350 configured to supply hydrogen to reversible device 310 when operated in fuel cell mode, and optionally receive hydrogen from reversible device 310 when operated in electrolyzer mode. Optionally, hydrogen unit 350 may comprise a hydrogen tank 352 for storing hydrogen and may comprise a compressor 354 for compressing hydrogen received from AEM device 310 into hydrogen tank 352. In electrolyzer mode, the generated hydrogen may be passed through a drying unit (not shown) and compressed, optionally electrochemically within AEM device 310, or optionally with the use of a mechanical, electrochemical or other compressor 354.

Self-refueling power-generating system 300 further comprises a water unit 340 configured to supply water (indicated schematically) and/or dilute electrolyte to reversible device 310. Water unit 340 may comprise a radiator 342 for dissipating heat and condensing water from reversible device 310 in the fuel cell mode, a liquid/gas separation module 344 for removing gases such as oxygen from the fluids received from reversible device 310 and a water pump 346 for pumping water to reversible device 310. Dilute alkaline electrolyte (e.g., at concentration lower than 3M) and/or deionized water may be circulated to control the operation temperature. The water circulation may be controlled to maintain the optimal operation temperatures in the fuel cell and electrolyzer modes. The circulated water or alkaline water may be supplied directly to oxygen side 141 (adjacent to oxygen-side catalyst layer 120 on electrode 142) via a circulation circuit which also serves as the water supply for hydrogen generation in the electrolyzer mode. Water that is generated by consumption of hydrogen during power generation in the fuel cell mode, may optionally be separated from the reactant gas/gases and returned to the water circulation circuit to replenish any water consumed during the hydrogen generation in the electrolyzer mode. Supply of water or dilute electrolyte to reversible device 310 may be carried out in a closed circuit and in conjunction with the supply of oxygen to reversible device 310.

In certain embodiments, gas/liquid separation module 344 may be configured to deliver separated oxygen from reversible device 310 (produced in electrolyzer mode) to oxidant unit 330, e.g., to compressor 334 and stored in an oxygen tank 332 (or alternatively using an air pump 333 for pumping, e.g., ambient air to supply oxidant). Water circulation may be provided directly to oxygen side 141 of reversible device 310 and the water may optionally be made alkaline by the addition of KOH or other alkaline salt, which may improve performance of reversible device 310. By combining the water and oxygen in the oxygen electrode, local relative humidity may be fixed at 145% due to the presence of excess liquid water. It is noted that while water consumption in the electrolyzer mode and water production in the fuel cell mode of reversible device 310 balance each other, some addition of water may be required due to system losses. A balance between oxygen and water supply may be controlled by controller 301 to optimize fuel cell performance, e.g., by using pure oxygen, and/or hydrophobizing or partially hydrophobizing the oxygen side catalyst layer and/or diffusion medium in membrane assembly 145, to preserve some areas free or partially free of liquid water and thereby allowing good access of the reactant oxygen to the catalyst surface. Water or dilute electrolyte may be stored in liquid/gas separation tank 344 or in an additional tank. A water supply line may optionally be included in system 300 to assure that the water supply is not depleted. In both power generation and hydrogen generation modes, the water continues to function as the temperature controlling fluid, and is still passed through the radiator to dissipate excess heat generated by either device.

Advantageously, by capturing the water generated in the fuel cell mode and the oxygen (in addition to the hydrogen) generated in the electrolyzer mode, system 300 may be entirely self-contained without need of any external supply of hydrogen, water or air/oxygen, needing only external power input 326 for refueling (hydrogen generation in the electrolyzer mode), thus retaining one of the key benefits of battery-based power systems while allowing a conceptually unlimited amount of energy capacity without the need for a larger device, a capability unavailable to battery systems.

Self-refueling power-generating system 300 further comprises a power connection unit 320 configured to receive power from reversible device 310 when operated in the fuel cell mode, e.g., as power output 325; and to deliver power to reversible device 310 when operated in an electrolyzer mode, e.g., as power input 326. Power connection unit 320 may be configured to deliver the received power to an external load when required, and to receive power for delivery from an external source when available. In various embodiments, power input 326 may be received from various sources, such as an electric grid, renewable energy resources and/or batteries, possibly selected according to their respective time-dependent cost and availability. For example, power input 326 may be selected from solar panels or wind turbines when these are available, according to method 400 disclosed herein. Self-refueling power-generating system 300 may be used as any of a backup electrical power generation system, portable power generation system or any other power generation system that is entirely independent of normal user intervention for refueling operations, but rather self-recharges whenever the fuel storage unit is not full and an external electrical power supply is available. Certain embodiments comprise a grid setup comprising a plurality of independent systems 300, that may use separate or shared hydrogen fuel storage 352, and optional oxygen storage 332, optional battery banks, and power sources 326 to provide a localized independent power supply solution to the users of that grid.

FIG. 10 is a high-level flowchart illustrating a method 450 of configuring a power-generating system to be self-refueling and self-sustaining, according to some embodiments of the invention. The method stages may be carried out with respect to system 300 and reversible device 310 described above, which may optionally be configured to implement method 450. Method 450 may be at least partially implemented by at least one computer processor, e.g., in a power-generating system the comprises a reversible device comprising (i) a stack of electrochemical cells with respective membrane assemblies, the device configured to be operated alternately as a fuel cell in a fuel cell mode and as an electrolyzer in an electrolyzer mode, wherein each of the membrane assemblies has a hydrogen-side catalyst layer configured to catalyze hydrogen oxidation in the fuel cell mode and to catalyze hydrogen formation in the electrolyzer mode and an oxidant-side catalyst layer configured to catalyze oxygen reduction in the fuel cell mode and to catalyze oxygen formation in the electrolyzer mode, the catalyst layers being separated by a separation layer, (ii) a hydrogen unit configured to supply hydrogen to the reversible device when operated in the fuel cell mode, and receive and optionally compress hydrogen from the reversible device when operated in the electrolyzer mode, and (iii) a power connection configured to receive power from the reversible device when operated in the fuel cell mode, and deliver power to the reversible device when operated in the electrolyzer mode, wherein the power connection is configured to deliver the received power to an external load when required, and to receive power for delivery from an external source when available. Certain embodiments comprise computer program products comprising a computer readable storage medium having computer readable program embodied therewith and configured to carry out any of the relevant stages of method 450. Method 450 may comprise the following stages, irrespective of their order.

Method 450 may comprise determining operation of the reversible device in the fuel cell mode or in the electrolyzer mode according to power requirements and power availability (stage 401), e.g., according to method 400, e.g., using artificial intelligence or machine learning algorithms and taking into account predetermined expected use cases, specific customer needs, time-criticality in increasing the available stored hydrogen, as well as power cost, source and availability.

In various embodiments, method 450 may further comprise any of: optimizing the hydrogen-side catalyst layer and the oxidant-side catalyst layer to operate in both the fuel cell mode and the electrolyzer mode according to specified requirements (stage 252), configuring the membrane assemblies to have the catalyst layers and the separation layer embedded in continuous polymerized ionomer material (stage 254), configuring the separation layer to comprise at least one layer that includes surface-charged particles that have a surface excess of charges, imparting ion conductivity along that surface when hydrated (stage 256), e.g., with the surface-charged particles comprising at least one of: charged clay particles, charged ceramic particles, graphene oxide particles, reduced or partially reduced graphene oxide particles and surface-charged polymer particles; and/or configuring the separation layer to have at least one protective layer adjacent to a respective one of the catalyst layers, to prevent dehydration thereof and/or exposure thereof to excessively oxidating and/or reducing conditions (stage 258).

Method 450 further comprises supplying oxygen to the reversible device in a closed circuit, by supplying oxygen to the reversible device when operated in the fuel cell mode, and receiving and compressing oxygen from the reversible device when operated in the electrolyzer mode (stage 460), and supplying water or dilute electrolyte to the reversible device in a closed circuit, by supplying and receiving water or dilute electrolyte in conjunction with the closed oxygen supply circuit by separating oxygen produced by the reversible device in the electrolyzer stage from the water or dilute electrolyte received from the reversible device (stage 470).

Advantageously, in use examples such as backup power scenarios, the most common operations would be to use a small portion of the available hydrogen. Given a reasonably predictable frequency of power outages, system 300 and method 450 may automatically run electrolysis at close to maximum efficiency and minimum refueling rate, and still expect the tanks to be full before the next outage. In use examples where power availability may be critical, the algorithm of method 400 may be optimized to refuel to some minimum critical amount of fuel at the maximum available rate, then run at maximum efficiency for the remaining refueling process. In use examples where cost of power supplied to the system for electrolysis is critical, system 300 may be configured to operate at maximum electrolysis efficiency. In examples use where system 300 is to be used next at a known future time, for example in some cases for portable power generation devices, the electrolysis operation could be fixed to a rate that delivers full tanks by an acceptable time ahead of the known next use.

FIG. 11 is a high-level schematic illustration of the operation of AEM and PEM reversible devices 310 in fuel cell mode 90A and in electrolyzer mode 90B, according to some embodiments of the invention. Disclosed membrane assemblies 145 and separation layer(s) 146 may be used for operation fuel cell mode 90A and in electrolyzer mode 90B, for which the principles of operation are briefly described. As non-limiting examples, implementations of fuel cell mode 90A and electrolyzer mode 90B with AEM (anion exchange membranes) and PEM (proton exchange membranes) are illustrated in a highly schematic manner. Each membrane assembly 145 in the stack of electrochemical cells typically has catalyst layers 144, 142 with corresponding catalysts that catalyze the respective reactions, as described briefly herein. In reversible devices 310 as disclosed herein, catalyst layers (electrodes) 144, 142 switch functions upon changing from fuel cell mode 90A to electrolyzer mode 90B, as explained below, e.g., anodes 144 in fuel cell mode 90A function as cathodes 144 in electrolyzer mode 90B and cathodes 142 in fuel cell mode 90A function as anodes 142 in electrolyzer mode 90B.

In fuel cell mode 90A, the electrochemical cells generate electricity (denoted schematically as “electricity out”) using a fuel (e.g., hydrogen) and an oxidizing agent (e.g., oxygen). In the case of hydrogen AEM fuel cell mode 90A, the hydrogen fuel is oxidized by hydroxide (OH⁻) anions formed at cathodic oxidant-side catalyst layer 120 of electrode 142 from a reaction of water with oxygen, and moving through separation layer(s) 146 to anodic hydrogen-side catalyst layer 120 of electrode 144, releasing electrons that travel through an external circuit to the cathode, thereby providing electrical power, as well as product water. In hydrogen PEM fuel cell mode 90A, the hydrogen is oxidized at anodic hydrogen-side catalyst layer 120 on electrode 144, releasing electrons that travel through an external circuit to cathodic oxidant-side catalyst layer 120 on electrode 142, thereby providing electrical power, and protons which move through separation layer(s) 146 to cathodic oxidant-side catalyst layer 120 on electrode 142 where they combine with oxygen to form product water.

In electrolyzer mode 90B, the electrochemical cells use electricity (denoted schematically as “electricity in”) to break down compounds (e.g., water) to yield products (e.g., hydrogen or other compounds). In AEM water electrolyzer mode 90B (including ones working with alkaline water, e.g., water with KOH), electricity is used to break down water to form hydrogen gas at cathodic hydrogen-side catalyst layer 120 on electrode 144, as well as hydroxide (OH⁻) anions that move through separation layer(s) 146 to anodic oxidant-side catalyst layer 120 on electrode 142, where they are reacted to form oxygen and water. In PEM electrolyzer mode 90B, water is broken down at anodic oxidant-side catalyst layer 120 on electrode 142 to yield oxygen gas and cations (e.g., protons) that move through separation layer(s) 146 to form hydrogen gas at cathodic hydrogen-side catalyst layer 120 on electrode 144.

Electrolyzer mode 90B is typically used to generate hydrogen for storage a future use, e.g., in fuel cell mode 90A. Reversible devices 310 may be optimized to operate alternatively, or alternately, in fuel cell mode 90A and in electrolyzer mode 90B. Reversible devices 310 may further comprise gas diffusion layers (GDLs) that allow gases and/or fluids through. Membrane assemblies 145 may comprise separation layer(s) 146, optionally one or both catalyst layers 120 on respective electrodes 144, 142 and optionally also corresponding gas diffusion layers. For example, membrane assemblies 145 may be configured to operate as membrane-electrode assemblies (MEAs) that are the core components of proton-exchange membrane fuel cells (PEMFCs) and proton-exchange membrane electrolyzers (PEMELs); as well as of anion-exchange membrane fuel cells (AEMFCs) and anion-exchange membrane electrolyzers (AEMELs). Membrane assemblies 145 may be manufactured separately from the electrodes, or one or even both electrodes 144, 142 may be deposited on membrane assembly 145 itself, forming respective catalyst-coated membranes (CCM). Alternatively or complementarily, the catalyst layers may be deposited on gas-diffusion layers (GDLs), forming gas diffusion electrodes (GDEs) that are pressed against membrane assembly 145 to form the respective stacks.

Reversible AEM/PEM devices 310 may be operated as either fuel cells 90A and/or electrolyzers 90B, depending on their operation conditions and material and energy flows. Power flow, and flows of hydrogen, oxygen and water may be reversed upon switching the operation mode of reversible AEM/PEM devices 310 and layer properties of reversible AEM/PEM devices 310 may be selected to operate effectively in both modes, as disclosed herein.

Separation layer(s) 146 may comprise one or more sheet(s) that may range in thickness from a few μm, through tens of μm and up to one or two hundred μm. Separation layer(s) 146 may comprise multiple thin sheets, some thin and some thicker sheets, or any operable combination of number and thickness of the sheets, reaching an overall thickness of up to 500 μm. The sheets of separation layer(s) 146 may be configured to combine high ionic conductivity, water transportability, mechanical strength and stability, and low gas permeation, and be optimized respectively as disclosed herein. For example, one or more sheets of separation layer(s) 146 may be configured to support other, main separation sheet(s) of separation layer(s) 146. The supporting sheets in separation layer(s) 146 may be very thin, e.g., hundreds of nanometers thick, tens of nm thick or even 10 nm, 5 nm or less in thickness, possibly down to the thickness of ceramic particles embedded therein themselves.

In various embodiments, separation layer(s) 146 may comprise ionomer membranes, membranes that incorporate ionic particles, and/or stabilizing structures such as mesh supports or particles, which may also limit membrane swelling upon water uptake. The thickness and order of multiple separation layers 146 may be configured to optimize the parameters required for each type of operation mode and respective performance requirements. Membrane assemblies 145 may include several functional separation layers 146, and may be manufactured in different ways, e.g., by multi-layer deposition upon any substrate (including e.g., GDL(s), GDE(s), catalyst layers as CCMs, etc.) or by attaching of multiple supported and/or unsupported layers of separation layer(s) 146, as disclosed herein.

Separation layer(s) 146 are configured to provide a gas-tight separation between electrodes 144, 142 and to conduct ions and transfer water between electrodes 144, 142. Separation layer(s) 146 are configured to have high ionic conductance (e.g., larger than any of 5 S·cm⁻², 10 S·cm⁻², 20 S·cm⁻², 50 S·cm⁻², 145 ·S·cm⁻², or intermediate values, when hydrated) to limit ohmic losses and high water permeance to limit device dry-out, e.g., by using high quality ionomers and/or by decreasing membrane thickness—either by reaching the limit for ultra-thin freestanding membranes or by using membranes supported by meshes, which however reduce the amount of available ionomer, yielding a tradeoff between the components contributing to ionic conductivity. It is noted that the conductance is the reciprocal of the area-specific resistance (ASR) of a layer such as a sheet or a membrane, and has units of S/cm². The conductance is a function of the layer's conductivity (which is a material property having units of S/cm), normalized by the thickness of that layer. For example, a 0.01 cm (145 μm) thick layer made of a material or composite with ion conductivity of 145 mS/cm, has a conductance of 10 S/cm² (145 mS/cm divided by 0.01 cm), and accordingly that layer has an ASR of 0.1 Ω·cm²). Disclosed separation layer(s) 146 and membrane assemblies 145 are characterized by a combination of high ionic conductivity, high mechanical strength, and low gas crossover.

Membrane assemblies 145 may be designed to optimize the performance of reversible devices 310 by adjusting the architecture of the electrodes to support the respective electrochemical and physical processes. For example, membrane assemblies 145 may be configured to assure percolation through the ionomer-rich phase to ensure ionic transport through membrane assembly 145 as a whole. Membrane assemblies 145 may further be configured to manage water transport within the ionomer, and to form, by configuration of the catalyst and support particles, a percolation network that provides electronic conductivity. Membrane assemblies 145 may further be configured to locate the catalyst particles accurately at the ionomer-pore interfaces, forming a three-phase interface, to support the catalytic processes (e.g., avoiding fully covering catalyst particles by ionomer and setting the catalyst particles close to the ionomer phase). Membrane assemblies 145 may be porous in order to provide a path for the gas reactants.

In non-limiting examples, hydrogen-side catalyst layer 120 on electrode 144 may include ionomer(s) with embedded hydrogen oxidizing and/or hydrogen evolving (generating) catalyst particles 132 such as nanoparticles made of any of Pt, Ir, Pd, Ru, Ni, Co, Fe and their alloys, blends and/or combinations, optionally supported on carbon or other conducting substrates. Alternatively or complementarily, hydrogen-side catalyst layer 120 on electrode 144 may comprise modified carbons with embedded catalytic groups such as nitrides or various transition metals. Alternatively or complementarily, hydrogen-side catalyst layer 120 on electrode 144 may comprise transition metal oxides or hydroxides based on Ni, Co, Mn, Mo, Fe, etc., nitrogen-doped and/or metal-doped carbon materials. Hydrogen-side catalyst layer 120 on electrode 144 may be between 2 μm to 20 μm thick (or within subranges such as 2 μm to 5 μm, 5 μm to 10 μm, 10 μm to 15 μm, 15 μm to 20 μm, or other intermediate ranges) and may have an ionomer content of between 0% to 40% w/w (or within subranges such as 0% to 10% w/w, 5% to 20% w/w, 10% to 30% w/w, 20% to 40% w/w, or other intermediate ranges). Hydrogen-side catalyst layer 120 on electrode 144 may be configured to be stable over the full voltage range of electrode operation, e.g., from under about −0.2 V in electrolyzer mode to over about +0.4V in fuel cell mode, versus a reversing hydrogen electrode.

Typical oxygen-side catalysts comprise metal oxide(s) and/or or metal hydroxide(s) that are stable over the full voltage range of electrode operation, e.g., from under about 0.6V in fuel cell mode to about 2.0V in electrolyzer mode versus a reversing hydrogen electrode. In non-limiting examples, oxygen-side catalyst layer 120 on electrode 142 may include ionomer(s) with embedded cathode catalyst particles 142 such as nanoparticles made of oxygen reducing and/or oxygen evolving (generating) catalysts made of any of Ag, Ag alloyed with Pt, Pd, Cu, Zr, Ag, Ni, Fe, Mn, Co, Pt, Ir, Ru their alloys, blends and/or combinations, possibly combined with metal oxides such as, e.g., cerium oxide, zirconium oxide, their alloys, blends and/or combinations. Alternatively or complementarily, oxygen-side catalyst layer 120 on electrode 142 may comprise the metal particles in oxide or hydroxide form and/or include surface oxide or hydroxide layers. Alternatively or complementarily, oxygen-side catalyst layer 120 on electrode 142 may comprise transition metal(s), metal oxide(s) and/or metal hydroxide(s) that are based on Ni, Fe, Co, Mn, Mo and their alloys, mixed oxides or mixed hydroxides such as spinel, perovskite or layered double hydroxide (LDH) structures, potentially doped with or loaded with Pt, Ir, Ru, Ag or other elements to enhance oxygen generation and/or reduction performance Oxygen-side catalyst layer 120 on electrode 142 may be 10 μm to 30 μm thick.

Gas diffusion layer(s) (GDLs) 135 and/or 145 may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, GDLs 135 and/or 145 may be attached to a microporous layer (MPL), made, e.g., from sintered carbon and/or optionally polytetrafluoroethylene (PTFE) or other hydrophobic particles, or from various porous metallic or other porous conductive layers.

In non-limiting examples of AEM implementations, the ionomeric material matrix may comprise a continuous anion conducting ionomer comprising, e.g., polymers or copolymers of (vinylbenzyl)trimethylammonium chloride, wherein the chloride counterion may be exchanged to any desired anion, copolymers of diallyldimethylammonium chloride (DADMAC), wherein the counterion may be exchanged to any desired anion, styrene-based polymers having quaternary ammonium anion conducting group, quaternized poly(vinylalcohol) (QPVA), bi-phenyl or tri-phenyl backboned polymers with one or more functional groups that could include alkyl tether group(s) and/or alkyl halide group(s) and/or equivalent groups, poly(arylpiperidinium) and other polymers containing cyclic quaternary ammonium in the backbone or on tethered sidechains, poly(bis-arylimidazoliums), cation-functionalized poly(norbornenes), neutral polymers or polymer membranes with grafted anion-conductive sidechains, or any other anion-conducting polymer. In some embodiments, the anion conducting ionomer may be crosslinked, e.g., using crosslinking agent(s) selected according to the type of the ionomer to be crosslinked, such as divinylbenzne, N,N,N′,N′-tetramethyl-1,6-hexanediamine (TMHDA), 1,4-diazabicyclo[2.2.2]octane (DABCO), glyoxal, glutaraldehyde, styrene based polymer(s) having quaternary ammonium anion conducting group(s), bi-phenyl or tri-phenyl backboned with one or more functional groups that could include alkene tether group(s) and/or alkyl halide group(s) and/or equivalent groups, hydrocarbon chains, sulfur groups, siloxy groups, N-hydroxybenzotriazole groups, azide groups and the like. In some embodiments, the anion conducting ionomer may be a blend of several polymers, some of which may not be anion conducting.

In non-limiting examples of PEM implementations, the ionomeric material matrix may comprise a continuous cation conducting ionomer comprising, e.g., poly(aryl sulfones), perfluorinated polysulfonic acids such as Nation®, polymers or copolymers of styrene sulfonic acid with various modifications, sulfonated polyimides, phosphoric acid-doped poly(benzimidazole), sulfonated poly(arylene ethers) such as sulfonated poly (ether ether ketone) (SPEEK) and/or other synthetic or natural cation exchange ionomers.

In certain embodiments, the stack of reversible device 310 in self-refueling power-generating system 300 may comprise membrane assemblies that include a hydrogen evolution/oxidation reaction (HER/HOR) electrode comprising a carbon-based gas diffusion electrode (GDE), and an oxygen evolution/reduction reaction (OER/ORR) electrode comprising a metal-based GDE—as provided in non-limiting examples of HER/HOR electrode 142 and OER/ORR electrode 144, disclosed herein. For example, in certain embodiments, the carbon-based GDE may comprises a gas diffusion layer (GDL), and a mixture comprising a catalyst dispersion and a binder dispersion, applied on the GDL, wherein the GDL with the applied mixture is hot pressed to form the GDE, and wherein the mixture comprises an ionomer, the catalyst dispersion comprises catalyst particles of one or more of: Ag, Pt, Ir, Pd, Ru, Ni, Co, Fe, Pd and their alloys, mixtures, oxides or mixed oxides, and the binder comprises at least one of Teflon, chlorotrifluoroethylene, perfluoroalkoxy alkane (PFA), ethylene tetrafluoroethylene, polyvinylidene fluoride and poly (methyl-methacrylate). In certain embodiments, the metal-based GDE may comprises a metal-based GDL, and a mixture comprising a catalyst dispersion and a binder dispersion, applied on the GDL, wherein the GDL with the applied mixture is hot pressed to form the GDE.

Embodiments of the present invention provide efficient and economical methods and mechanisms for preparing gas diffusion electrodes (GDEs) and thereby provide improvements to the technological field of electrochemical devices such as electrolyzers, fuel cells and combined bi-directional systems. Methods of preparing gas diffusion electrodes (GDEs) for electrochemical devices such as electrolyzers and fuel cells are provided. The GDEs comprise a gas diffusion layer (GDL), and a mixture comprising a catalyst dispersion and a binder (e.g., Teflon) dispersion, applied on the GDL, wherein the GDL with the applied mixture is hot pressed to form the GDE. GDLs may be carbon-based or metal-based, and ionomer may be added to improve performance if needed. Briefly hot pressing the layer at or near the glass temperature of the binder improves the adhesion of the layer and its cohesivity, which improves its long-term performance and durability in electrolyzer and/or fuel cell applications. For example, the catalyst dispersion may comprise a catalyst dispersion and the GDE may be a hydrogen evolution reaction (HER) electrode operable in an electrolyzer. In another example, the catalyst dispersion may comprise a catalyst dispersion, the mixture may further comprise an ionomer, and the GDE may be an oxygen reduction reaction (ORR) electrode operable in a fuel cell. Certain embodiments comprise electrodes that may be operable reversibly, e.g., be used as HER/HOR electrodes and/or OER/ORR electrodes, for example in reversible devices (e.g., dual cells) that can be operated alternately in fuel cell and electrolyzer modes. Typically fuel cell electrodes may be made with carbon-based GDLs and the fuel cells may be operated with ionomeric electrolyte, while electrolyzer OER electrode may be made with metal-based GDLs and the electrolyzer may be operated with liquid electrolyte. Dual cells may be configured with carbon-based GDLs for the HER/HOR electrodes and with metal-based GDLs for the OER/ORR electrodes. Either or both types of GDEs may be prepared with binder material and be hot-pressed to improve their performance and/or durability.

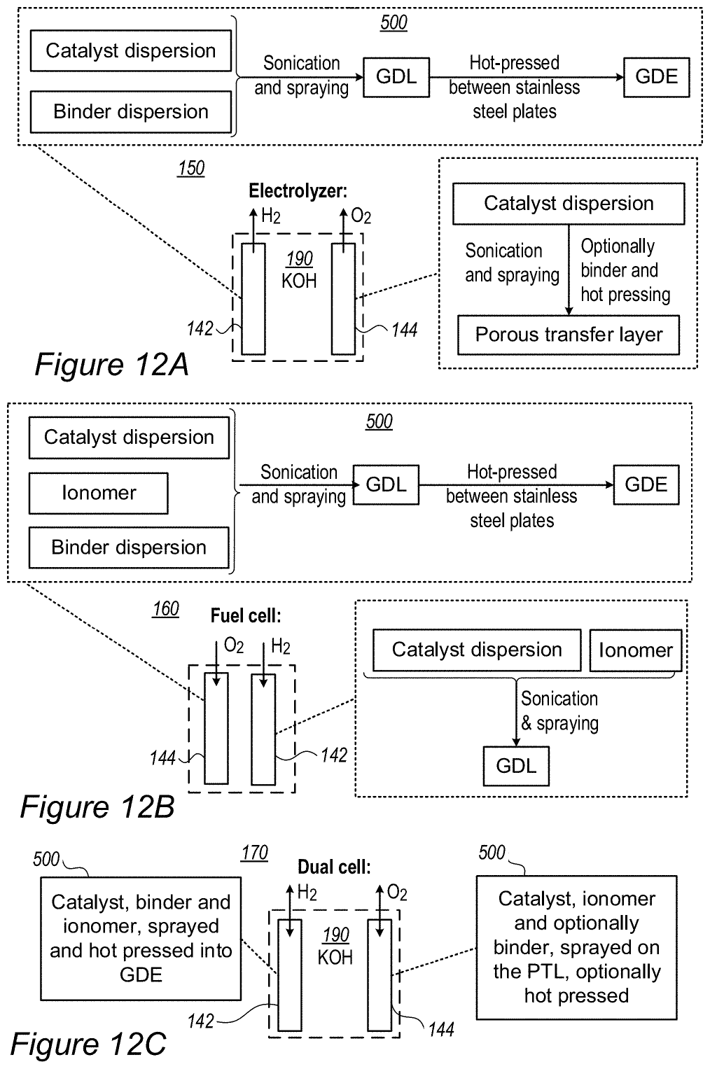

FIG. 12A is a high-level schematic block diagram of an electrolyzer 150, according to some embodiments of the invention. Electrolyzer 150 comprises GDE 112 as HER made of the GDL with the applied mixture of catalyst dispersion and binder dispersion (e.g., comprising Teflon)—hot pressed thereupon, and further comprising a catalyst-coated porous transfer layer as an oxygen evolution reaction (OER) electrode 114 and electrolyte 190. In certain embodiments, OER electrode 114 with metal-based GDL may likewise include binder material and be hot-pressed. Electrolyte 190 may be alkaline and comprise e.g., KOH, K₂CO₃ and/or KHCO₃ solutions at concentrations up to 10M (e.g., 0.01M, 0.1M, 1M, 1-5M, 3-10M or intermediate values) or may possibly comprise water (with ionomer material combined in the catalytic layer providing ionic conductivity).

The binder material may be selected to enhance the stability and the durability of the electrode, particularly when hot pressed. Binder materials may comprise one or more materials, which have (i) low glass transition temperatures (e.g., Tg<180° C.), (ii) low swelling properties (e.g., less than 80% swelling in X-Y direction in wet conditions, at 80° C. , OH— form)—to make the respective electrode mechanically stable, (iii) sufficient chemical stability at alkaline conditions (e.g., 1M KOH), (iv) prolonged thermal stability, e.g., being stable above 145° C. for at least 1450 h. Specific examples for alternative binders include chlorotrifluoroethylene, perfluoroalkoxy alkane (PFA), ethylene tetrafluoroethylene, polyvinylidene fluoride or poly (methyl-methacrylate) or any combination of these materials. In any of the disclosed embodiments, the binder material may comprise Teflon and/or any binder(s) which conform to these requirements. In any of the embodiments in which Teflon is used, Teflon may be partly or fully replaced by other types of appropriate binders.

In any of the disclosed embodiments, hot pressing may be optimized with respect to the type of binder and with respect to other GDE components—to yield the most stable and most efficient electrode, depending on performance requirements. For example, hot pressing may be carried out within the temperature range of 80-180° C. (depending on the Tg of the selected binder as well as on the type of ionomer and other electrode materials) and carried out for the ranges of few seconds to a few minutes (e.g., between ten seconds and ten minutes).

In non-limiting examples, a mixture of catalyst (e.g., Pt) dispersion in a solvent (e.g., 2-propanol and DI (deionized) water) and binder (e.g., Teflon) dispersion in water may be applied (e.g., sonicated and sprayed) on the GDL, which may then be pressed between plates to form GDE 112. OER electrode 114 may comprise catalyst (e.g., Ni) dispersion in the solvent (e.g., 2-propanol and DI water), applied (e.g., sonicated and sprayed) on a Ni PTL (porous transport layer). In certain embodiments, OER electrode 114 may be produced as a PTL, using binder dispersion and hot pressing, e.g., with respective catalysts/binders coated on the metal-based PTL and hot pressing for OER electrode 114. OER electrode 114 may further comprise ionomer material, or comprise catalyst and binder material (e.g., Teflon) without additional ionomer.

FIG. 12B is a high-level schematic block diagram of a fuel cell 160, according to some embodiments of the invention. Fuel cell 160 comprises GDE 144 as ORR made of the GDL with the applied mixture of catalyst dispersion, ionomer and binder (e.g., Teflon) dispersion hot pressed thereupon, and further comprising a hydrogen oxidation reaction (HOR) electrode 142. For example, HOR electrode 142 may comprises a catalyst (e.g., Pt) dispersion and ionomer, applied (e.g., sonicated and sprayed) on a HOR GDL. The ionomer material may provide ionic conductivity, without requiring electrolyte solution in fuel cell 160.

In non-limiting examples, a mixture of catalyst (e.g., Ag) dispersion in solvent (e.g., 2-propanol and DI water), ionomer and binder (e.g., Teflon) dispersion in water may be applied (e.g., sonicated and sprayed) on the GDL, which may then be pressed between plates, for example stainless steel plates or other types of plates, to form GDE 144. HOR electrode 142 may comprise catalyst dispersion in solvent (e.g., 2-propanol and DI water) mixed with ionomer and applied (e.g., sonicated and sprayed) on a GDL.

In various embodiments, the solvent(s) may comprise, e.g., any of water, 2-propanol, ethanol, methanol, N-methyl-2-pyrrolidone, toluene, tetra-hydro-furan and/or combinations thereof with different ratios. Any of the dispersions may be formulated as an ink for the corresponding form of application.

In certain embodiments, GDEs (with carbon-based GDLs) may be used in fuel cells 160 both as ORR electrode 144 and as HOR electrode 142, with corresponding adjustments.

FIG. 12C is a high-level schematic block diagram of a dual cell 170, according to some embodiments of the invention. Dual cell 170 may be reversible, configured to operate alternately (and reversibly) as electrolyzer 150 and fuel cell 160, depending on the operation conditions of dual cell 170, namely whether electricity is provided to dual cell 170 to generate hydrogen and oxygen by electrolysis (and be operated as electrolyzer 150, with electrolyte 190 comprising water or an alkaline solution) or whether hydrogen and oxygen are delivered to dual cell 170 to generate electricity (and be operated as fuel cell 160). Correspondingly, both GDEs, namely HER/HOR electrode 142 and OER/ORR electrode 144, may be produced as disclosed herein, by spraying catalyst dispersion, binder (e.g., Teflon) and ionomer material of respective GDLs and hot pressing them to form the respective GDEs. Clearly the exact details of the catalyst type, binder (e.g., Teflon) concentration and ionomer type and concentration may be optimized to provide the required ionic conductivity and electrode stability, e.g., from the options disclosed herein, with respect to specific assembly and operation parameters of dual cell 170. In certain embodiments, OER/ORR electrode 144 may be produced as a PTL, using binder dispersion and hot pressing, e.g., with respective catalysts/binders coated on the metal-based PTL and hot pressing for OER/ORR electrode 144. OER/ORR electrode 144 may further comprise ionomer material, or comprise catalyst and binder material (e.g., Teflon) without additional ionomer.

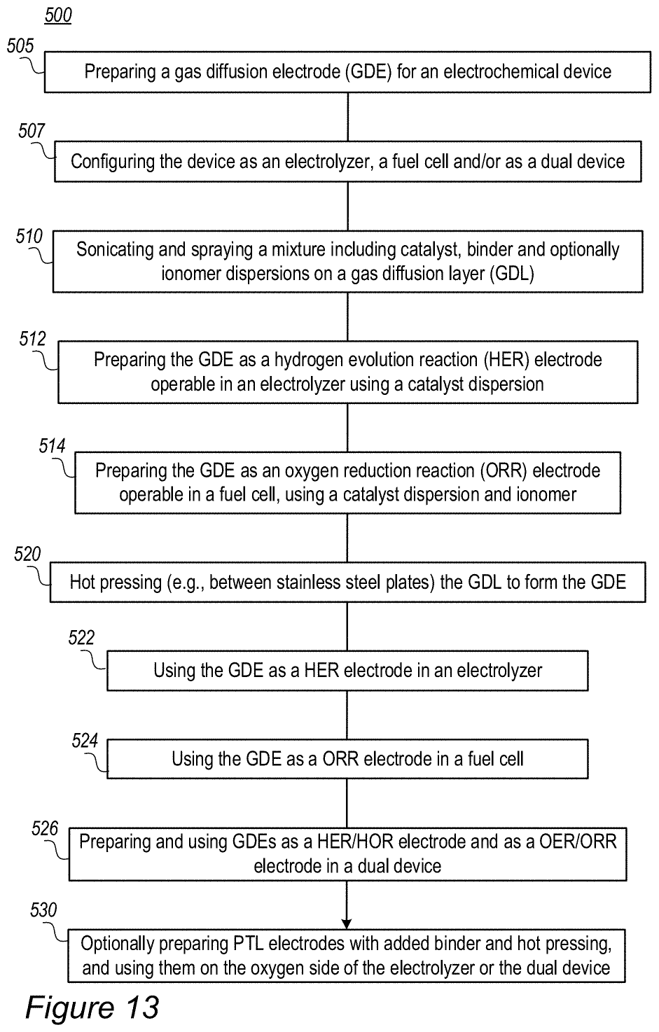

FIG. 13 is a high-level flowchart illustrating a method 500, according to some embodiments of the invention. The method stages may be carried out with respect to the disclosed GDE electrodes, electrolyzer 150 and/or fuel cells 160 described above, which may optionally be configured to implement method 500. Method 500 may comprise the following stages, irrespective of their order.

Method 500 may comprise preparing a gas diffusion electrode (GDE) for an electrochemical device (stage 505), the method comprising: sonicating and spraying a mixture on a gas diffusion layer (GDL), wherein the mixture comprises a catalyst dispersion and a binder dispersion (stage 510), and hot pressing the GDL to form the GDE (stage 520), for example at the glass transition temperature of the binder, and e.g., between plates.

In certain embodiments, method 500 may comprise preparing the GDE using a catalyst dispersion (stage 512), e.g., Pt, and using the GDE as a hydrogen evolution reaction (HER) electrode operable in an electrolyzer (stage 522), e.g., with a catalyst-coated porous transport layer (PTL) as an OER electrode and KOH electrolyte.

In certain embodiments, method 500 may comprise preparing the GDE using a catalyst (e.g., Ag) dispersion and ionomer (stage 514) and using the GDE as an oxygen reduction reaction (ORR) electrode operable in a fuel cell (stage 524), e.g., with a catalyst (e.g., Pt) dispersion and ionomer, sonicated and sprayed on a HOR GDL and KOH electrolyte.

In certain embodiments, method 500 may comprise configuring the device as an electrolyzer, fuel cell and/or a dual device (stage 507), with respective GDEs as ORR electrodes for fuel cells, HER electrodes for electrolyzers and/or preparing and using GDEs as a HER/HOR electrode and as a OER/ORR electrode in a dual device (stage 526). Method 500 may thus comprise using the GDEs to form a dual cell, that is operable alternately as an electrolyzer and as a fuel cell (with both GDEs including ionomer).

In various embodiments, disclosed uses of binder and hot pressing may be applied to one or both types of electrodes in each type of device. For example, in fuel cells, only ORR electrode or both ORR and HOR electrodes may be produced using binder dispersion and hot pressing, e.g., with respective catalysts/binders coated on respective carbon-based GDLs. In electrolyzers, only HER electrode or both HER and OER electrodes may be produced using binder dispersion and hot pressing, e.g., with respective catalysts/binders coated on carbon-based GDL for the HER electrode and on metal-based PTL for the OER electrode. In dual systems, the OER/ORR (on metal-based PTL) electrodes and the HER/HOR (on carbon-based GDL) electrodes may be produced using binder dispersion and hot pressing as disclosed herein. Specifically, in certain embodiments, PTL electrodes may be prepared with added binder and hot pressing, and be used on the oxygen side of the electrolyzer or the dual device (stage 530).

In various embodiments, catalyst dispersion for either electrode may include other types of catalysts, such as other members of the platinum group metals (PGMs), non-supported or supported on carbon. For example, the hydrogen-side catalyst layer may include ionomer(s) with embedded hydrogen oxidizing and/or hydrogen evolving (generating) catalyst particles such as nanoparticles made of any of Pt, Ir, Pd, Ru, Ni, Co, Fe, Pd—CeOₓ and their alloys, blends and/or combinations, optionally supported on carbon or other conducting substrates. Alternatively or complementarily, the hydrogen-side catalyst layer may comprise modified carbons with embedded catalytic groups such as nitrides or various transition metals. Alternatively or complementarily, the hydrogen-side catalyst layer may comprise transition metal oxides or hydroxides based on Ni, Co, Mn, Mo, Fe, etc., nitrogen-doped and/or metal-doped carbon materials. The hydrogen-side catalyst layer may have an ionomer content of between 0% to 40% w/w (or within subranges such as 0% to 10% w/w, 5% to 20% w/w, 10% to 30% w/w, 20% to 40% w/w, or other intermediate ranges). The hydrogen-side catalyst layer may be configured to be stable over the full voltage range of electrode operation, e.g., from under about −0.2 V in electrolyzer mode to over about +0.4V in fuel cell mode, versus a reversing hydrogen electrode. In non-limiting examples, the oxygen-side catalyst layer may include ionomer(s) with embedded cathode catalyst particles such as nanoparticles made of oxygen reducing and/or oxygen evolving (generating) catalysts made of any of NiFe₂O₄, Perovskites, Fe, Zn, Ag, Ag alloyed with Pt, Pd, Cu, Zr, Ag, Ni, Fe, Mn, Co, Pt, Ir, Ru their alloys, blends and/or combinations, possibly combined with metal oxides such as, e.g., cerium oxide, zirconium oxide, their alloys, blends and/or combinations. Alternatively or complementarily, the oxygen-side catalyst layer may comprise the metal particles in oxide or hydroxide form and/or include surface oxide or hydroxide layers. Alternatively or complementarily, the oxygen-side catalyst layer may comprise transition metal(s), metal oxide(s) and/or metal hydroxide(s) that are based on Ni, Fe, Co, Mn, Mo and their alloys, mixed oxides or mixed hydroxides such as spinel, perovskite or layered double hydroxide (LDH) structures, potentially doped with or loaded with Pt, Ir, Ru, Ag or other elements to enhance oxygen generation and/or reduction performance

Gas diffusion layer(s) (GDLs) and/or may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, the GDLs may be attached to a microporous layer (MPL), made, e.g., from sintered carbon and/or optionally polytetrafluoroethylene (PTFE) or other hydrophobic particles, or from various porous metallic or other porous conductive layers.

In various embodiments, the PTL (porous transport layer) may be made of the following materials: Ni, various grades of stainless steel, titanium or any combination of all of them together. In addition, it can be either felt, mesh, or dual layers, with different porosity values and different thicknesses. The PTL may be used with or without a mesoporous layer (MPL).

In non-limiting examples of AEM and/or PEM implementations, the ionomeric material matrix may comprise respective materials as described herein for respective AEM/PEM ionomeric material matrix.

Non-limiting examples and experimental results are provided in the following. In these examples, the combination of using Teflon material and brief hot-pressing was used to enhance the performance of the respective electrodes with respect to their stability and durability. GDEs with 5 cm² active area were prepared and tested in respective sealed electrolyzer and fuel cell configurations.

In the electrolyzer configurations, catalyst dispersion was applied to yield a loading of 0.17 mg/cm² on the HER GDE. The Teflon dispersion had a 60% wt % and 1.5 gr/ml density (in water) with particle size between 0.05-0.5 mm. Mixtures with Teflon content ranging between 3 wt %, 6 wt % and 10 wt % were compared. The mixture was sonicated for 15 minutes and sprayed by a spray gun on Freudenberg carbon paper GDLs, and then hot-pressed at 119° C. to change the Teflon to amorphous structure near its Tg (glass transition temperature). The Ni PTL OER electrode was prepared in a similar manner of spraying, without using Teflon, ionomer or applying hot pressing. The electrolyzer cells were assembled using Ni500 flow fields, stainless steel end plates, 50 μm PTFE sub-gaskets and 250/160 μm thick PTFE gaskets at the cathode/anode sides, respectively, sealed under a torque of 7 Nm.

In the fuel cell configurations, the catalyst dispersion was applied to yield a loading of 2.5 mg/cm² on the ORR GDE, with a 4 wt % commercial ionomer. The Teflon dispersion had a 60% wt % and 1.5 gr/ml density (in water) with particle size between 0.05-0.5 μm and an overall Teflon content of 3 wt %. The HOR electrode was prepared in a similar manner of spraying a mixture of catalyst dispersion applied to yield a loading of 1.4 mg/cm² and including 12 wt % commercial ionomer. Both mixtures were sonicated for 15 minutes and sprayed by a spray gun on Freudenberg nonwoven carbon GDLs with microporous layer. The ORR GDE was hot-pressed at 119° C. for 3 minutes at a pressure of 106 kg/cm², to change the Teflon to amorphous structure at its Tg (glass transition temperature). The fuel cells were assembled and sealed using 500 μm thick Kapton polyimide gaskets on both electrodes, under a torque of 7 Nm.

The inventors note that the Teflon and hot pressing helped keep the uniformity and integrity of the catalyst layer, preventing cracks and voids from being created during the durability test, and practically maintaining the layer morphology throughout the fuel cell operation. It is suggested that the Teflon binder creates a fine net that contributes to the stability of the layer, fixes its morphology and in small quantity does not interfere too much with the hydrophilicity/hydrophobicity of the layer, thereby keeping its good ionic conductivity-that is essential for stable durability test. In contrast, in prior art electrodes without Teflon and hot pressing, the catalyst layer is less uniform and exhibits non-patterned channels, cracks and voids that seem to have been created during the durability test, probably decreasing the voltage are related to leaching of ionomer and catalyst material which, together with reduced conductivity and formation of inactive regions contribute to fuel cell degradation. It is noted that upon applying hot pressing without addition of Teflon only minor changes in electrode durability have been observed. It is further noted that the exact percentage of Teflon and parameters of the hot pressing may change and be optimized with respect to the size, constituents and purpose of the electrode.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of making alkaline exchange catalytic electrodes for an electrochemical device, the method comprising:
preparing a catalyst dispersion by mixing at least one type of catalyst nanoparticles and at least one polymer precursor dispersion in a solvent, the at least one polymer precursor comprising at least two types of monomer units having respective at least two types of functional groups that comprise at least one non-cationic functional group, and at least one anion-conductive functional group,
depositing the catalyst dispersion on a functional substrate and evaporating the solvent to form a catalyst layer, and
crosslinking at least one of the non-cationic functional groups and/or the anion-conductive groups to stabilize the catalyst layer.

2. The method of claim 1, wherein the at least one anion-conductive functional group comprises a cationic functional group and/or a functional group that can be chemically treated to form cationic functional group.

3. The method of claim 1, wherein the functional substrate comprises at least one of an anion exchange membrane, a porous gas diffusion layer and/or porous gas transport layer.

4. The method of claim 1, wherein the preparing of the catalyst dispersion further comprises mixing into the catalyst dispersion a crosslinking agent selected to react with two or more of the non-cationic functional groups to form crosslinks in the electrode.

5. The method of claim 1, wherein the crosslinking comprises reacting the at least one of the non-cationic functional groups and/or the cationic functional groups with a crosslinking agent by contacting the electrode with the crosslinking agent.

6. The method of claim 5, wherein the contacting comprises at least one of: immersing the electrode in a bath containing the crosslinking agent, a dispersion thereof or a solution thereof, and optionally activating the crosslinking reaction.

7. The method of claim 6, wherein the crosslinking is carried out by at least one of:
immersing the electrode in a hot bath of dihalide, adding dithiol and/or dihalide and/or diamine to the catalyst dispersion and/or by heating the electrode in solvent vapor.

8. The method of claim 1, further comprising repeating the deposition of the catalyst dispersion at least twice, with two different polymer precursors in each of the catalyst dispersions.

9. The method of claim 8, further comprising repeating the crosslinking at least twice.

10. The method of claim 1, further comprising repeating the deposition of the catalyst dispersion at least twice, with the same polymer precursors in each of the catalyst dispersions.

11. The method of claim 10, further comprising repeating the crosslinking at least twice.

12. The method of claim 11, further configures to form a catalyst layer coated by a polymer layer, and wherein the crosslinking is carried out to form crosslinked bonds that extend across an interface between the catalyst layer and the polymer layer.

13. The method of claim 1, wherein the crosslinking is carried out with dithiol and/or dihalide and/or diamine functional groups.

14. The method of claim 1, wherein the at least one anion-conductive functional group comprises a quaternary ammonium.

15. The method of claim 1, further comprising chemically treating the catalyst layer to make at least one anion-conductive functional group—cationic groups.

16. The method of claim 1, wherein the functional substrate comprises a mesh for supporting the crosslinked ionomer.

17. The method of claim 1, wherein the crosslinking comprises forming a dithioether type crosslink of the form P—R—S—R′—S—R—P, with S denoting a sulfur atom, and/or an alkyl or aryl crosslink of the form P—R—P, wherein P represents the ionomer chains being crosslinked, R and R′ each being an alkyl or an aryl chain.

18. A membrane-electrode assembly comprising two catalytic electrodes separated by an anion-conducting separation layer, wherein at least one of the electrodes is prepared by the method of claim 1.

19. A reversible electrochemical device comprising the membrane-electrode assembly of claim 19, wherein the two catalytic electrodes comprise a hydrogen evolution/oxidation reaction (HER/HOR) electrode comprising a carbon-based gas diffusion electrode (GDE), and an oxygen evolution/reduction reaction (OER/ORR) electrode comprising a metal-based GDE.
